(19) United States
(12) Patent Application Publication
(10) Pub. No.: US 2021/0324195 A1
(43) Pub. Date: Oct. 21, 2021

(54) Composition for Silicone Rubber Masses

(71) Applicant: Nitrochemie Aschau GmbH, Aschau am lnn (DE)

(72) Inventors: Klaus Langerbeins, Pulheim (DE); Alexis Krupp, Waldkraiburg (DE); Ulrich Pichl, Aschau (DE)

(73) Assignee: Nitrochemie Aschau GmbH, Aschau am lnn (DE)

(21) Appl. No.: 17/269,434

(22) PCT Filed: Aug. 20, 2019
(86) PCT No.: PCT/EP2019/072280

§ 371 Date: Feb. 18, 2021

(30) Foreign Application Priority Data
Aug. 20, 2018 (EP) 18189821.4

(51) Int. Cl. C08L 83/04; C08K 5/549; C08K 5/5465

(52) U.S. Cl. CPC C08L 83/04; C08K 3/36; C08K 5/5465; C08K 5/549

(57) ABSTRACT

A composition containing a curing agent for silicone rubber masses and an organosilane, in particular a heterocyclic organosilane, as well as sealing agents, adhesives or coating agents containing this composition, the use of this composition as a sealing agent, adhesive or coating agent and the use of an organosilane according to the invention, in particular a heterocyclic organosilane as a water scavenger, alcohol scavenger and/or hydroxide ion scavenger and, after activation, as an adhesion promoter in silicone rubber masses is presented and described.

The invention relates to a composition comprising a curing agent for silicone rubber compositions and an organosilane, preferably a cyclic organosilane, sealants, adhesives or coating agents comprising said composition, the use of said composition for preparing a silicone rubber composition, its use as a sealant, adhesive or coating agent and the use of said organosilanes as adhesion promoters in silicone rubber compositions.

Cold-curing silicone rubber compounds, also known as RTV (room temperature curing) silicone rubber compounds, are known as tailor-made materials with elastic properties. They are widely used as sealants, as jointing material or as adhesives for glass, porcelain, ceramics, stone, plastics, metals, wood, etc., especially in the sanitary sector, in building construction or as coating materials. Cold-curing silicone rubber compounds are preferably used as one-component RTV silicone rubber compounds (RTV-1). Such silicone rubber compounds are usually plastically deformable mixtures of polyorganosiloxanes with functional groups and suitable crosslinking agents, in particular suitable curing agents, which are stored under exclusion of moisture. These mixtures crosslink under the influence of water or air humidity at room temperature. This process is usually referred to as curing. The curing agents used in this process are often also referred to as crosslinking agents. In addition, adhesion promoters are regularly used in silicone rubber masses. In silicone rubber compounds (e.g. sealants or adhesives), they assume the important property of ensuring good adhesion to various substrates.

The properties of cured silicone rubber compounds are largely determined by the polyorganosiloxanes used, the curing agents and adhesion promoters. For example, the degree of crosslinking of the cured silicone rubber mass can be controlled depending on the use of tri- and/or tetra-functional curing agents. The degree of crosslinking has a considerable influence on, for example, the solvent resistance of the cured silicone rubber compound. The adhesion promoters used also modify the properties of the resulting sealants, e.g. through interaction with the other components of the formulation. Adhesion promoters are usually substances that can interact with both the silicone rubber compound and the substrate. Up to now, this has usually been achieved via compounds that carry a silane group and a further, reactive functional group. Sometimes organosilanes with reactive amino, carboxy, epoxy or thiolato groups are used. The reactive functional group interacts with the substrate. Organosilanes with reactive amino groups are used particularly frequently, for example in the form of trimethoxy[3-(methylamino)propyl]silane.

A disadvantage of these reactive compounds, especially the particularly reactive primary and secondary amine compounds, is their low specificity towards possible reaction partners. For example, in addition to the desired reactions of adhesion promoters with the substrate, side reactions are also observed. Such side reactions often take place before the sealants are discharged. These side reactions are primarily exchange reactions between the organosilane adhesion promoters and other silanes, in particular with the silane crosslinkers also present in the composition. This can have an effect not only on the function of the adhesion promoter, but also on the function of the silane crosslinkers which are also present in the composition. In particular, the exchange reactions result in the consumption of the adhesion promoter.

For example, it is known from the prior art that during compounding of sealing compounds containing different silane curing agents or silane curing agents in combination with organosilane adhesion promoters, an active substituent exchange takes place between the silanes.

In this context, WO 2016/146685 A1 reveals new and stable silanes as crosslinkers containing at least one special α-hydroxycarboxylic acid amide residue, their preparation and the associated curable compositions. The preparation of the new crosslinker types is carried out by exchange reactions between aminosilane compounds and silanes of the general formula Si(R¹)ₘ(R²)₄₋ₘ.

These compositions therefore contain an increased concentration of aminosilane compounds as adhesion promoters, which in addition to their adhesive properties also stabilize the crosslinkers.

A further disadvantage of this process is that uncontrolled exchange can result in compounds that are released in an uncontrolled manner as leaving groups during curing, for example.

From WO 2018/011360 A1, crosslinker/adhesive agent combinations are known. The negative influence of reactive amine groups was eliminated by using special acyclic adhesion promoter structures in combination with special crosslinkers.

However, the range of application is limited to special compounds and it is therefore desirable to be able to use a wider selection of potentially suitable adhesion promoters.

Accordingly, the object of the invention is to overcome at least one of the disadvantages described.

This object is achieved by the compositions indicated in claims 1 to 14, the process indicated in claim 15 and the uses indicated in claims 18 to 20.

Advantageous embodiments of the invention are explained in detail below.

The composition according to the invention contains
a. a curing agent for silicone rubber masses comprising a compound having the general structural formula R¹ₘSi(R)₄₋ₘ,
   wherein
   each R¹ independently represents an optionally substituted straight-chain or branched C1 to C16 alkyl group, an optionally substituted straight-chain or branched C2 to C16 alkenyl group or an optionally substituted C4 to C14 aryl group,
   m is an integer from 0 to 2,
   each R is independently selected from the group consisting of
      a hydroxycarboxylic acid ester residue having the general structural formula (I):

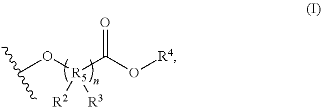

wherein
each R² independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group each R³ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group R⁴ represents an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group, a C5 to C15 aralkyl group or a C4 to C14 aryl group,
R⁵ is C or an optionally substituted saturated or partially unsaturated cyclic ring system having 4 to 14 C atoms or an optionally substituted aromatic group having 4 to 14 C atoms, and
n is an integer from 0 to 10,
   a hydroxycarboxylic acid amide residue of the general structural formula (II):

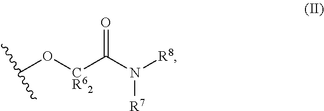

wherein
each R⁶ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group each R⁷ or R⁸ independently represents H or an optionally substituted, straight-chain or branched C1 to C16 alkyl group, an optionally substituted, straight-chain or branched C2 to C16 alkenyl group or an optionally substituted, straight-chain or branched C2 to C16 alkynyl group or a C4 to C14 aryl group
—O—C(O)—R⁹, wherein R⁹ represents H, an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group or a C4 to C14 aryl group, and
—O—N═CR¹⁰ R¹¹, wherein R¹⁰ and R¹¹ independently represent H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group, and
b. at least one organosilane, in particular a heterocyclic organosilane, as water scavenger, alcohol scavenger and/or hydroxide ion scavenger and
c. optionally at least one organopolysiloxane.

Surprisingly, it has been found that the use of organosilanes, especially heterocyclic organosilanes, produces silicone rubber masses with improved adhesion promotion properties. These organosilanes can be used as adhesion promoters after activation. Depending on the compound, activation can be effected by ring opening (in the case of heterocyclic organosilanes) or, for example, by splitting off protective groups or other cleavage products. After activation, the organosilane is present as a primary or secondary amine. This can then serve as an adhesion promoter.

It is not necessary to use organosilanes, especially heterocyclic organosilanes in excess. They can be present in low concentrations, since side reactions, which are regularly observed in conventional non-cyclic coupling agents with silane crosslinkers, can be inhibited. They are also suitable as water scavengers, alcohol scavengers or hydroxide ion scavengers and can thus simultaneously improve the storage stability of silicone rubber masses.

In a particularly preferred embodiment of the invention, the composition therefore contains a maximum of 3 wt.-%, preferably a maximum of 2 wt.-%, further preferably a maximum of 1.5 wt.-%, in particular preferably a maximum of 1.1 wt.-% organosilanes, in particular heterocyclic organosilanes, each based on the total weight of the composition.

It has been shown that silicone rubber compounds, in particular the sealant formulations containing the composition according to the invention, exhibit particularly advantageous adhesion to various substrates, such as glass, metal, and various polymers, in particular polyamide, polystyrene or Metzoplast. The improved adhesion is preferably achieved already at low concentrations of the adhesion promoters.

The improved adhesion is already observed in a further preferred design at a proportion of organosilanes, in particular heterocyclic organosilanes, of 0.25 to 3 wt.-%, preferably of 0.25 to 2 wt.-%, particularly preferably of 0.5 to 1.5 wt.-%, particularly preferably of 0.8 to 1.2 wt.-%, based on the total weight of the silicone rubber masses.

It has been also found that the compositions according to the invention show a high storage stability. Furthermore, the resulting silicone rubber masses, especially sealant formulations, exhibit advantageous properties, in particular good tear resistance, as well as a pleasant odor, and are colorless and transparent. Without being bound to a scientific theory, the effect of the composition according to the invention seems to be traceable to the special chemical structure of the organosilanes, especially heterocyclic organosilanes. In particular, the exchange reactions between the crosslinkers and adhesion promoters known to experts in the field of silanes can probably be prevented. The potential adhesion promoter does not appear to be consumed and is thus completely available for adhesion promotion after the sealant formulations have been discharged. Furthermore, the combinations of curing agents with organosilanes, especially heterocyclic organosilanes, according to the invention, seem to be highly compatible with each other. In addition to the adhesion promoting properties of the hydrolyzed organosilanes, especially the hydrolyzed heterocyclic organosilanes after discharge of the sealant formulation, these compounds can also act as water, alcohol or hydroxide ion scavengers. This is the reason for the increased stability of the composition according to the invention.

Reaction Scheme 1 (Function of the Water Trap):

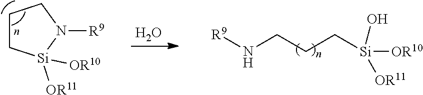

The use of heterocyclic organosilanes and their reaction as water scavengers according to the invention is illustrated in reaction scheme 1. The initially cyclic compound opens up by adding water. By using such “masked aminosilanes”, it is surprisingly possible that they act as water, alcohol, or hydroxide ion scavengers in a reaction and thus act as a stabilizer in a composition according to the invention and thus produce advantageous silicone rubber masses.

Advantageously, the organosilanes which can be used according to the invention are aminosilane compounds according to one of the general structural formulae (III), (IIIa), (IIIb), (IV), (IVa), (V), (Va), (VI), (VIa) and/or (VII) (see below) or mixtures thereof. These are particularly suitable for performing the function of a water, alcohol or hydroxide ion scavenger in the composition according to the invention.

Alternatively, the organosilanes, in particular masked aminosilanes, may preferably be selected from the group consisting of iminosilanes of the general structural formula (VII), silanoaminosilanes of the general structural formula (VIII), non-cyclic organosilanes of the general structural formula (IX), amino-protecting group-containing organosilanes (IXa) to (IXe) derived from the general structural formula (IX) or mixtures thereof:

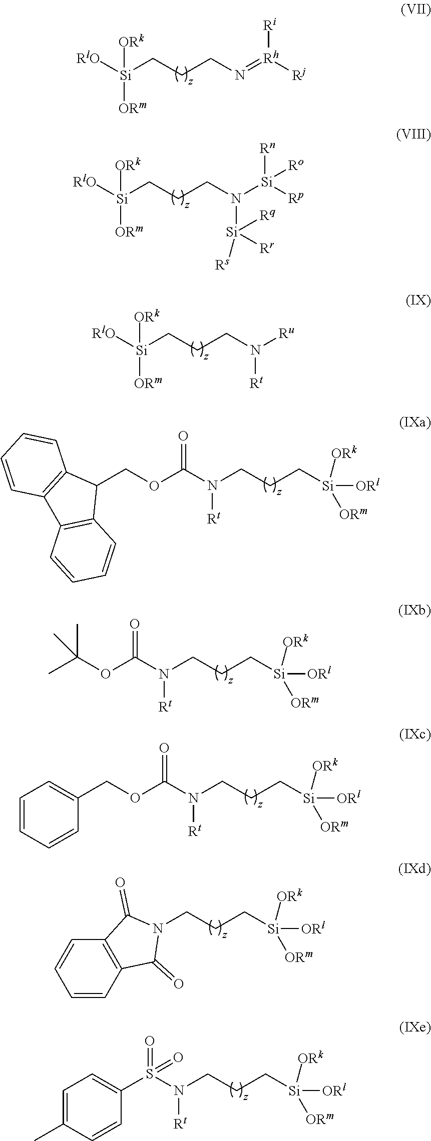

wherein
   R^{h} is C or Si,
   each Rⁱ, R^{j} independently represents H, —C(O)R^{t}, an optionally substituted straight-chain or branched C1 to C16 alkyl group, an optionally substituted straight-chain or branched C2 to C16 alkenyl group, or an optionally substituted C4 to C14 aryl group
   each R^{k}, R^{l}, R^{m} independently represents H, —C(O)R^{t}, an optionally substituted, straight-chain or branched C1 to C16 alkyl group, an optionally substituted, straight-chain or branched C2 to C16 alkenyl group, or an optionally substituted C4 to C14 aryl group
   each Rⁿ, R^{o}, R^{p}, R^{q}, R^{r}, R^{s} independently represents H, —O—R^{t}, —C(O)—R^{t}, —COOR^{t}, an optionally substituted, straight-chain or branched C1 to C16 alkyl group, an optionally substituted, straight-chain or branched C2 to C16 alkenyl group, or an optionally substituted C4 to C14 aryl group
   each R^{t}, R^{u} independently represents H, —ORⁱ, —C(O)Rⁱ, —C(O)CF₃, —COORⁱ, an optionally substituted straight-chain or branched C1 to C16 alkyl group, an optionally substituted straight-chain or branched C2 to C16 alkenyl group, an optionally substituted C4 to C14 aryl group, or a protecting group, in particular a tert-butoxycarbonyl group, a fluorenylmethoxycarbonyl group, a benzyloxycarbonyl group, an allyloxycarbonyl group, an optionally substituted isoindole-1,3-dione group or a 3-methyl-benzenesulfone group, and
   z is an integer from 1 to 30.

In a preferred embodiment, the composition according to the invention contains at least one masked aminosilane of any of the above definitions.

Further surprisingly, it has been found that the organosilanes according to the invention, especially heterocyclic organosilanes, are preferably suited to reduce the odor load of different crosslinkers, especially oxime crosslinkers. If certain heterocyclic organosilanes, which preferably carry trialkylsilyl groups, are added to curable compositions containing crosslinkers with malodorous leaving groups, in particular oxime crosslinkers, the odor load can be reduced, if not completely neutralized. Without being bound to a scientific theory, the heterocyclic organosilane seems to react with the leaving groups in such a way that structures are obtained, which represent a reduced, preferably no olfactory load. The heterocyclic organosilanes appear to act as trialkylsilyl transfer reagents.

A common trimethylsilyl transfer reagent, such as 1,3-bis(trimethylsilyl)urea (BSU) can thus be added preferentially to the compositions according to the invention.

Practical tests have shown that the transfer reagents can also act as stabilizers and thus not only have a positive effect on the olfactory properties of the resulting sealants, but can also have a positive influence on the storage stability of the compositions.

Surprisingly, it has also been shown that certain organosilanes, especially heterocyclic organosilanes, can also be used as stabilizers in addition to their adhesion-promoting properties. Thus, the compositions according to the invention preferably contain heterocyclic organosilanes which carry a trialkylsilyl group, in particular a trimethylsilyl group, on at least one heteroatom.

Further preferred stabilizers would be dialkoxy(trialkylsilyl)azasilacycloalkyls, especially preferred compounds are selected from the group consisting of 2,2-dimethoxy-1-(trimethylsilyl)aza-2-silacyclopentane, 2,2-diethoxy-1-(trimethylsilyl)aza-2-silacyclopentane, 2,2-dimethoxy-1-(trimethylsilyl)aza-2-silacyclohexane, 2,2-diethoxy-1-(trimethylsilyl)aza-2-silacyclohexane, 2,2-dimethoxy-1-(triethylsilyl)aza-2-silacyclopentane, 2,2-diethoxy-1-(triethylsilyl)aza-2-silacyclopentane, 2,2-dimethoxy-1-(triethylsilyl)aza-2-silacyclohexane and 2,2-diethoxy-1-(triethylsilyl)aza-2-silacyclohexane, in particular preferably 2,2-dimethoxy-1-(trimethylsilyl)aza-2-silacyclopentane and 2,2-diethoxy-1-(trimethylsilyl)aza-2-silacyclopentane.

“Crosslinkers” are in particular silane compounds capable of crosslinking, which have at least two groups which can be split off by hydrolysis. Examples of such crosslinkable silane compounds are Si(OCH₃)₄, Si(CH₃)(OCH₃)₃ and Si(CH₃)(C₂H₅)(OCH₃)₂. Crosslinkers can also be called curing agents. “Crosslinker” also includes in particular “crosslinker systems”, which may contain more than one crosslinkable silane compound.

“Sealants” or “sealing compounds” means elastic materials applied in liquid to viscous form or as flexible profiles or webs for sealing a surface, in particular against water, gases or other media.

The term “sealant” as used herein describes the cured composition according to one of the claims.

The term “alkyl group” means a saturated hydrocarbon chain. Alkyl groups have in particular the general formula —CₙH₂ₙ₊₁. The term “C1 to C16 alkyl group” refers in particular to a saturated hydrocarbon chain with 1 to 16 carbon atoms in the chain. Examples of C1 to C16 alkyl groups are methyl, ethyl, propyl, butyl, isopropyl, iso-butyl, sec-butyl, tert-butyl, n-pentyl and ethylhexyl. Accordingly, a “C1 to C8 alkyl group” refers in particular to a saturated hydrocarbon chain with 1 to 8 carbon atoms in the chain. In particular, alkyl groups may also be substituted, even if this is not specifically stated.

“Straight-chain alkyl groups” means alkyl groups that do not contain any branches. Examples of straight-chain alkyl groups are methyl, ethyl, n-propyl, n-butyl, n-pentyl, n-hexyl, n-heptyl and n-octyl.

“Branched alkyl groups” means alkyl groups which are not straight-chain, i.e. in which the hydrocarbon chain in particular has a fork. Examples of branched alkyl groups are isopropyl, iso-butyl, sec-butyl, tert-butyl, sec-pentyl, 3-pentyl, 2-methylbutyl, iso-pentyl, 3-methylbut-2-yl, 2-methylbut-2-yl, neopentyl, ethylhexyl, and 2-ethylhexyl.

“Alkenyl groups” means hydrocarbon chains containing at least one double bond along the chain. For example, an alkenyl group with one double bond has in particular the general formula —CₙH₂ₙ₋₁. However, alkenyl groups can also have more than one double bond. The term “C2 to C16 alkenyl group” refers in particular to a hydrocarbon chain with 2 to 16 carbon atoms in the chain. The number of hydrogen atoms varies depending on the number of double bonds in the alkenyl group. Examples of alkenyl groups are vinyl-, allyl-, 2-butenyl- and 2-hexenyl-.

“Straight-chain alkenyl groups” means alkenyl groups which do not contain any branches. Examples of straight-chain alkenyl groups are vinyl, allyl, n-2-butenyl and n-2-hexenyl.

“Branched alkenyl groups” means alkenyl groups which are not straight-chain, i.e. wherein in particular the hydrocarbon chain has a fork. Examples of branched alkenyl groups are 2-methyl-2-propenyl-, 2-methyl-2-butenyl- and 2-ethyl-2-pentenyl-.

“Alkynyl groups” means hydrocarbon chains containing at least one triple bond along the chain. For example, an alkynyl group containing a triple bond has in particular the general formula —CₙH₂ₙ₋₂. However, alkynyl groups can also have more than one triple bond. In particular, alkynyl groups can also contain an alkenyl group in addition to an alkynyl group. The term “C2 to C16 alkynyl group” means in particular a hydrocarbon chain with 2 to 16 carbon atoms in the chain. The number of hydrogen atoms varies depending on the number of triple bonds and, optionally, double bonds in the alkynyl group. Examples of alkynyl groups are ethyne, propyne, 1-butyne, 2-butyne and hexyne, 3-methyl-1-butyne, 2-methyl-3-pentynyl.

“Straight-chain alkynyl groups” means alkynyl groups that do not contain any branches. Examples of straight-chain alkynyl groups are ethyne, propyne, 1-butyne, 2-butyne and hexyne.

“Branched alkynyl groups” means alkynyl groups which are not straight-chain, i.e. where the hydrocarbon chain in particular has a fork. Examples of branched alkynyl groups are 3-methyl-1-butyl-, 4-methyl-2-hexynyl- and 2-ethyl-3-pentenyl-.

“Aryl groups” means monocyclic (e.g. phenyl), bicyclic (e.g. indenyl, naphthalenyl, tetrahydronapthyl, or tetrahydroindenyl) and tricyclic (e.g. fluorenyl, tetrahydrofluorenyl, anthracenyl, or tetrahydroanthracenyl) ring systems in which the monocyclic ring system or at least one of the rings in a bicyclic or tricyclic ring system is aromatic. In particular, a C4 to C14 aryl group means an aryl group having 4 to 14 carbon atoms. In particular, aryl groups can also be substituted, even if this is not specifically stated.

An “aromatic group” means cyclic, planar hydrocarbons with an aromatic system. An aromatic group with 4 to 14 carbon atoms refers in particular to an aromatic group containing 4 to 14 carbon atoms. The aromatic group can be monocyclic, bicyclic or tricyclic. An aromatic group can also contain 1 to 5 heteroatoms selected from the group consisting of N, O, and S. Examples of aromatic groups are benzene, naphthalene, anthracene, phenanthrene, furan, pyrrole, thiophene, isoxazole, pyridine and quinoline, wherein in the above examples the necessary number of hydrogen atoms is removed in each case to allow incorporation into the corresponding structural formula. For example, in a structural formula HO—R*—CH₃, where R* is an aromatic group with 6 carbon atoms, especially benzene, two hydrogen atoms would be removed from the aromatic group, especially benzene, to allow incorporation into the structural formula.

A “cycloalkyl group” means a hydrocarbon ring that is not aromatic. In particular, a cycloalkyl group with 4 to 14 C atoms means a non-aromatic hydrocarbon ring with 4 to 14 carbon atoms. Cycloalkyl groups can be saturated or partially unsaturated. Saturated cycloalkyl groups are not aromatic and have no double or triple bonds. In contrast to saturated cycloalkyl groups, partially unsaturated cycloalkyl groups have at least one double or triple bond, but the cycloalkyl group is not aromatic. In particular, cycloalkyl groups can also be substituted, even if this is not specifically stated.

A “ring” means cyclic compounds consisting exclusively of hydrocarbons and/or partly or wholly of heteroatoms. The heteroatoms are preferably selected from the group consisting of Si, N, P, S or O. Preferably, aromatic compounds are also included. In particular, a ring includes the heterocyclic organosilanes according to the claims.

The term “ring atom” describes atoms that are part of a cyclic structure.

“Organosilane” means a compound consisting of at least one carbon atom and at least one silicon atom

The term “heterocyclic organosilane” means a heterocycle containing at least one silicon atom and at least one other heteroatom. In particular, the heteroatom may be directly linked to the silicon atom.

A “heterocycle” means a cyclic ring system containing 1 to 10 heteroatoms, preferably selected from the group consisting of Si, N, P, S or O.

Unless otherwise specified, H means in particular hydrogen, N means in particular nitrogen. Furthermore, O means in particular oxygen, S means in particular sulfur, P means in particular phosphorus, unless otherwise specified.

The term “primary bond” is an umbrella term for a class of chemical bonding types. The primary bonds include the ionic bond, the molecular bond (i.e. covalent bond) and the metal bond.

“Secondary bonds” means a generic term for a class of chemical bonds. Secondary bonds include in particular the hydrogen bridge bond, the dipole-dipole bond and the Van-der-Waals bond.

“Optionally substituted” means that hydrogen atoms in the corresponding group or radical may be replaced by substituents. Substituents may in particular be selected from the group consisting of C1 to C4 alkyl, methyl, ethyl, propyl, butyl, phenyl, benzyl, halogen, fluorine, chlorine, bromine, iodine, hydroxy, amino, alkylamino, dialkylamino, C1 to C4 alkoxy, phenoxy, benzyloxy, cyano, nitro, and thio. When a group is designated as optionally substituted, 0 to 50, especially 0 to 20, hydrogen atoms of the group may be replaced by substituents. When a group is substituted, at least one hydrogen atom is replaced by a substituent.

“Alkoxy” means an alkyl group which is connected to the main carbon chain or the main skeleton of the compound via an oxygen atom.

The term “organopolysiloxane” means a composition according to the invention which contains at least one organosilicone compound, preferably two, three or more different organosilicone compounds. An organosilicone compound contained in the composition is preferably an oligomeric or polymeric compound. The polymeric organosilicone compound is preferably a difunctional polyorganosiloxane compound, particularly preferably an α,ω-dihydroxyl-terminated polyorganosiloxane. Particularly preferred are α,ω-dihydroxyl terminated polydiorganosiloxanes, especially α,ω-dihydroxyl terminated polydialkylsiloxanes, α,ω-dihydroxyl terminated polydialkenylsiloxanes or α,ω-dihydroxyl terminated polydiarylsiloxanes. In addition to homopolymeric α,ω-dihydroxyl-terminated polydiorganosiloxanes, heteropolymeric α,ω-dihydroxyl-terminated polydiorganosiloxanes with different organic substituents can also be used, whereby both copolymers of monomers with similar organic substituents on a silicon atom and copolymers of monomers with different organic substituents on a silicon atom are included, e.g. those with mixed alkyl, alkenyl and/or aryl substituents. The preferred organic substituents include straight and branched alkyl groups with 1 to 8 carbon atoms, in particular methyl, ethyl, n- and iso-propyl, and n-, sec- and tert-butyl, vinyl and phenyl. In the individual organic substituents, individual or all carbon-bonded hydrogen atoms may be substituted by common substituents such as halogen atoms or functional groups such as hydroxyl and/or amino groups. Thus α,ω-dihydroxyl-terminated polydiorganosiloxanes with partially fluorinated or perfluorinated organic substituents can be used or α,ω-dihydroxyl-terminated polydiorganosiloxanes with organic substituents on the silicon atoms substituted by hydroxyl and/or amino groups can be used.

Particularly preferred examples of an organosilicone compound are α,ω-dihydroxyl-terminated polydialkylsiloxanes, such as α,ω-dihydroxyl-terminated polydimethylsiloxanes, α,ω-dihydroxyl-terminated polydiethylsiloxanes or α,ω-dihydroxyl-terminated polydivinylsiloxanes, and α,ω-dihydroxyl-terminated polydiarylsiloxanes, such as α,ω-dihydroxyl-terminated polydiphenylsiloxanes. Polyorganosiloxanes with a kinematic viscosity of 5,000 to 120,000 cSt (at 25° C.) are preferred, especially those with a viscosity of 20,000 to 100,000 cSt, and especially preferred those with a viscosity of 40,000 to 90,000 cSt. Blends of polydiorganosiloxanes with different viscosities can also be used.

Both reinforcing and non-reinforcing fillers can be used as “fillers”. Preferably, inorganic fillers are used, such as highly disperse, pyrogenic or precipitated silicas, carbon black, quartz powder, chalk, or metal salts or metal oxides, such as titanium oxides. A particularly preferred filler is a highly dispersed silica, such as Cabosil 150 from Cabot. Fillers such as highly disperse silicas, especially fumed silicas, can also be used as thixotropic agents. Metal oxides can also be used as colorants, e.g. titanium oxides as white colorants. The fillers can also be surface modified by conventional methods, e.g. silicas hydrophobized with silanes can be used.

“Plasticizers” are additives that can influence the deformability or viscosity of the material. They can be added to a composition to change the physicochemical properties of the material. Suitable representatives of such plasticizers are, for example, high-boiling esters of polybasic acids, such as citric acid esters, phthalic acid esters, phosphoric acid derivatives, especially compounds of the formula O═P(OR)₃, wherein R means alkyl, alkoxyalkyl, phenyl or aralkyl, especially isopropyl-phenyl, phosphonic acid derivatives, in particular phosphorous acid esters or salts of phosphonic acids, fatty acid derivatives, fumaric acid derivatives, glutamic acid derivatives, in particular esters or salts of glutamic acid, high-boiling alcohols, such as polyols, in particular glycols, polyglycols and glycerol, it being possible for these to be terminally esterified if appropriate. Sulphonic acid derivatives, such as toluene sulphonamides, epoxy derivatives, preferably epoxidised natural oils, such as compounds of the general formula CH₃—(CH₂)n -A-(CH₂)n —R, wherein A preferably comprises an alkene with one or more double bonds, (e.g. unsaturated fatty acids), n is at maximum 25 and R is C2 to C15 alkyl, epoxidized fatty acid ester derivatives, epoxidized soybean oil, epoxidized linseed oil, alkyl epoxy tallates, alkyl epoxy sebacates, ricinoleates; adipates; chlorinated kerosene oil; polyesters comprising polycaprolactone-triol; glutaric acid polyesters; adipic acid polyesters; silicone oils; mixtures of linear or branched saturated hydrocarbons, preferably having at least 9 carbon atoms, in particular mineral oils or combinations thereof.

The term “adhesive” means substances that connect wing parts by surface adherence (adhesion) and/or internal strength (cohesion). This term covers in particular glue, paste, dispersion adhesives, solvent adhesives, reaction adhesives and contact adhesives.

“Coating agent” means any agent for coating a surface.

In the meaning of the invention, “potting compounds” or also “cable potting compounds” are hot or cold processable compounds for potting cables and/or cable accessories.

In the above-mentioned definitions, the necessary valency of the corresponding constituent for incorporation into a structural formula, if not specified, is self-evident to the skilled person.

It has been shown that certain combinations of crosslinker types with cyclic aminosilanes are particularly advantageous. In particular, they produce compositions with advantageous properties such as reduced odor, particularly high storage stability or improved mechanical or optical properties.

Therefore, the composition according to the invention contains in a further embodiment of the invention
a. a curing agent for silicone rubber masses comprising a compound having the general structural formula R¹ₘSi(R)₄₋ₘ,
   wherein
   each R¹ independently represents an optionally substituted straight-chain or branched C1 to C16 alkyl group, an optionally substituted straight-chain or branched C2 to C16 alkenyl group or an optionally substituted C4 to C14 aryl group,
   m is an integer from 0 to 2,
   each R is independently selected from the group consisting of
      a hydroxycarboxylic acid ester residue having the general structural formula (I):

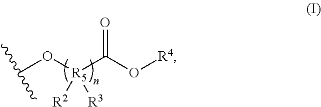

wherein
each R² independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group each R³ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group R⁴ represents an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group, a C5 to C15 aralkyl group or a C4 to C14 aryl group,
R⁵ is C or an optionally substituted saturated or partially unsaturated cyclic ring system having 4 to 14 C atoms or an optionally substituted aromatic group having 4 to 14 C atoms, and
n is an integer from 0 to 10,
—O—N═CR¹⁰ R¹¹, wherein R¹⁰ and R¹¹ independently represent H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group,
and
b. at least one organosilane, in particular a heterocyclic organosilane as water scavenger, alcohol scavenger and/or hydroxide ion scavenger and
c. optionally at least one organopolysiloxane.

The excellent adhesion of the resulting silicone rubber masses according to the invention can be achieved by adding the organosilanes, especially heterocyclic organosilanes, especially in combination with the crosslinkers according to the invention at low concentrations.

Therefore, the composition in a particularly preferred embodiment of the invention contains a maximum of 3 wt.-%, preferably a maximum of 2 wt.-%, further preferably a maximum of 1.5 wt.-%, particularly preferably a maximum of 1.1 wt.-% organosilanes, in particular heterocyclic organosilanes, each based on the total weight of the composition.

The improved adhesion is already observed in a further preferred embodiment at a proportion of organosilanes, in particular heterocyclic organosilanes, of 0.25 to 3 wt.-%, preferably of 0.25 to 2 wt.-%, particularly preferably of 0.5 to 1.5 wt.-%, particularly preferably of 0.8 to 1.2 wt.-%, based on the total weight of the silicone rubber compounds.

According to another embodiment of the invention, the composition contains a heterocyclic organosilane, which is preferably a 4- to 10-membered heterocycle.

Particularly advantageous properties of the compositions according to the invention are obtained if the ring size of the heterocyclic organosilanes does not exceed 8 atoms, preferably 7 atoms, further preferably 6 atoms.

In a particularly advantageous embodiment, the composition therefore contains at least one heterocyclic organosilane that is a 5- to 6-membered heterocycle.

In another embodiment, the heterocycle can contain a maximum of 5 heteroatoms. Here the heteroatoms are especially selected from the group consisting of Si, N, P, S or O, preferably Si or N.

Furthermore, in certain cases it can be advantageous if the heterocyclic organosilane consists exclusively of silicon and heteroatoms. In a preferred embodiment, these heteroatoms are selected from the group consisting of Si, N, P, S or O, preferably Si or N.

In a particularly preferred embodiment, the compositions of the invention contain heterocyclic organosilanes which have a heterocycle with at least one nitrogen atom.

Furthermore, it may be advantageous to modify the periphery of the heterocyclic organosilanes in order to increase the steric demand. For this purpose, the heterocyclic organosilane can be linked to at least one other ring according to one embodiment.

In a particularly preferred embodiment, heterocyclic organosilanes are preferred which are linked to at least one other ring via a covalent bond.

Preferably the ring can be attached to the heterocyclic organosilanes by means of condensation reactions. This way of attaching further rings is well known in the art and is also called annellation. In the resulting ring systems, at least two of the original rings share an atomic bond at the joining point.

In addition to the annelated rings, bridged ring structures can be advantageous in a further embodiment. Bridged ring structures contain especially ring atoms which share two atomic bonds of different rings and are not directly adjacent. Examples of molecules containing bridged ring structures are the norbornanes or ansa compounds.

It also includes compounds containing spiroatoms. These spiro compounds are in particular polycyclic compounds whose rings are linked together only at one atom, the spiro atom.

The silicon atom of the heterocyclic organosilanes carries at least one OR^{d} residue according to a particularly preferred embodiment. Preferably, each R^{d} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group. Preferably, R^{d} is selected from the group consisting of H, an optionally substituted C1 to C10 straight-chain or branched alkyl group, an optionally substituted C2 to C10 straight-chain or branched alkenyl group, an optionally substituted C2 to C10 straight-chain or branched heteroalkyl group, an optionally substituted C3 to C10 straight-chain or branched cycloalkyl group, or an optionally substituted C4 to C8 aryl or heteroaryl group. Particularly preferably, R^{d} represents H, an optionally substituted straight-chain or branched C1 to C8 alkyl group, an optionally substituted straight-chain or branched C2 to C8 alkenyl group, an optionally substituted straight-chain or branched C4 to C8 heteroalkyl group, an optionally substituted C4 to C6 cycloalkyl group, or an optionally substituted C5 to C6 aryl or heteroaryl group.

In a further embodiment of the invention, the silicon atom may also carry at least one NR^{d1}R^{d1} residue. Each R^{d1} here is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group. Preferably, R^{d1} represents H, or an optionally substituted straight-chain or branched C1 to C10 alkyl group, an optionally substituted straight-chain or branched C2 to C10 alkenyl group, an optionally substituted straight-chain or branched C2 to C10 heteroalkyl group, an optionally substituted straight-chain or branched C2 to C10 cycloalkyl group, or an optionally substituted C4 to C8 aryl or heteroaryl group. Particularly preferred is R^{d1} H, an optionally substituted straight-chain or branched C1 to C8 alkyl group, an optionally substituted straight-chain or branched C2 to C8 alkenyl group, an optionally substituted straight-chain or branched C4 to C8 heteroalkyl group, an optionally substituted C4 to C6 cycloalkyl group, or an optionally substituted C5 to C6 aryl or heteroaryl group.

In a preferred embodiment, the heteroatom of the cyclic organosilane in the composition according to the invention may also be directly bonded to another organosilane, preferably a heterocyclic organosilane.

The heteroatom can be linked to the organosilane, especially heterocyclic organosilane in a more preferred embodiment via a secondary bond and/or a primary bond. The organosilane, in particular the heterocyclic organosilane, is linked by an ionic bond, a covalent bond and/or a hydrogen bond in a more preferred embodiment. In particular, the heteroatom is linked to the organosilane, especially the heterocyclic organosilane, by a covalent molecular bond to the heteroatom.

In a further embodiment of the invention, the heteroatom of the heterocyclic organosilane is connected to the further organosilane, in particular heterocyclic organosilane, via one or more carbon atoms.

The linkage can be done in a preferred embodiment via a secondary bond and/or a primary bond. The organosilane, in particular the heterocyclic organosilane, is linked in a preferred embodiment by an ionic bond, a covalent bond and/or a hydrogen bond. in particular, the heteroatom is linked to the organosilane, in particular heterocyclic organosilane, by a covalent molecular bond with the heteroatom.

In a particularly preferred embodiment of the invention, the compositions according to the invention contain heterocyclic organosilanes which have at least one of the following structural formulae (III) to (V) and (IIIa) to (Va)

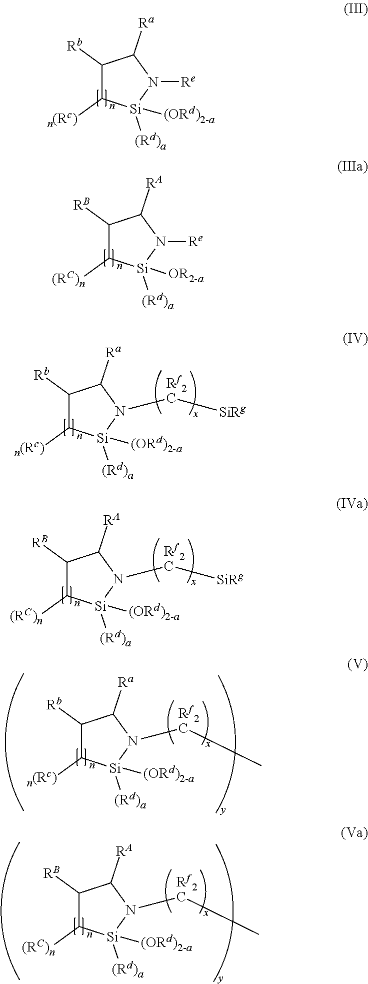

The parameter a in (R^{d})ₐ or (R^{d1})ₐ means the ratio of alkoxy groups to groups R^{d}, which are defined as herein. Therein a can take values from 0 to 2. If a=0, the corresponding heterocyclic organosilane contains no R^{d} radical and two OR^{d} radicals. The parameter a can also be 1. In this case, one R^{d} radical and one OR^{d} radical is directly connected to the silicon atom of the heterocyclic organosilane. If a=2, again only R^{d} residues and no OR^{d} residues are connected to the silicon atom;

x in the structural formulae (IV), (IVa), (V) or (Va) according to the invention means the chain length of the carbon chain (CR^{f}2) which is connected to the nitrogen atom of the heterocyclic organosilane Here, x can assume values from 0.1 to 100.0, preferably from 0.1 to 30.0, particularly preferably from 0.5 to 10.0; y determines in the structural formulae (V) and (Va) the number of individual heterocyclic organosilanes connected to one another directly or via a carbon chain and can assume values from 1.0 to 1000.0, preferably from 1.0 to 100.0, more preferably from 1.0 to 30.0, particularly preferably from 1.0 to 10.0.

Unless otherwise specified, the ranges of x or y values given include all conceivable decimal numbers, especially integer and half integer values for x or y.

The ring size of the heterocyclic organosilanes in each of the general structural formulae (III) to (V) and (IIIa) to (Va) is determined by the parameter n in the structures. The structural formulae and n result in possible ring sizes of 4 (for n=0) to 10 (for n=6).

The residues (R^{c})ₙ in the structural formulae (III) to (V) and (R^{C}), from the structural formulae (IIIa) to (Va) are each directly related to the ring size determined by the parameter n. The possible number of residues on the ring atoms is also adjusted by the value n. For example, if there is a 6 ring, n=2 and the number of residues R^{c} or R^{e} is adjusted to 2. Thus, each ring atom can carry one residue.

The heterocyclic organosilane may carry different residues on each ring atom, each R^{a}, R^{b}, R^{c}, R^{d}, R^{e}, R^{f} or R^{g} from structural formulae (III), (IV) or (V) is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted straight, branched or cyclic C4 to C20 alkynyl group or an optionally substituted straight or branched C2 to C20 heteroalkyl group, an optionally substituted straight, branched or cyclic C3 to C20 heteroalkenyl group or an optionally substituted C4 to C14 aryl or heteroaryl group. Preferably R^{d1} means H, or an optionally substituted straight-chain or branched C1 to C10 alkyl group, an optionally substituted straight-chain or branched C2 to C10 alkenyl group, an optionally substituted straight-chain or branched C2 to C10 heteroalkyl group, an optionally substituted straight-chain or branched C2 to C10 cycloalkyl group, an optionally substituted C3 to C10 cycloalkyl group, or an optionally substituted C4 to C8 aryl or heteroaryl group. Particularly preferred is R^{d1} H, an optionally substituted straight-chain or branched C1 to C8 alkyl group, an optionally substituted straight-chain or branched C2 to C8 alkenyl group, an optionally substituted straight-chain or branched C4 to C8 heteroalkyl group, an optionally substituted C4 to C6 cycloalkyl group, or an optionally substituted C5 to C6 aryl or heteroaryl group.

Alternatively, the heterocyclic organosilanes may carry further rings in addition to the substitution patterns just described.

The rings can be formed in such a way that each R^{A} and R^{B} or R^{A} and (R^{C})ₙ of the structural formulae (IIIa), (IVa) or (Va) together form a 4- to 10-membered ring, preferably a 5- to 8-membered ring, especially preferably a 5- to 6-membered ring.

In a further embodiment, R^{B} and each of the possible (R^{C}), in the structural formulae (IIIa), (IVa) or (Va) can alternatively form a 4- to 10-membered ring, preferably a 5- to 8-membered ring, especially preferably a 5- to 6-membered ring.

In a further preferred embodiment of the invention, the compositions according to the invention may contain one or more organosilanes selected from the group consisting of iminosilanes of the general structural formula (VII), silanoaminosilanes of the general structural formula (VIII), non-cyclic organosilanes of the general structural formula (IX), amino-protective group-containing organosilanes (IXa) to (IXe) derived from the general structural formula (IX) or mixtures thereof:

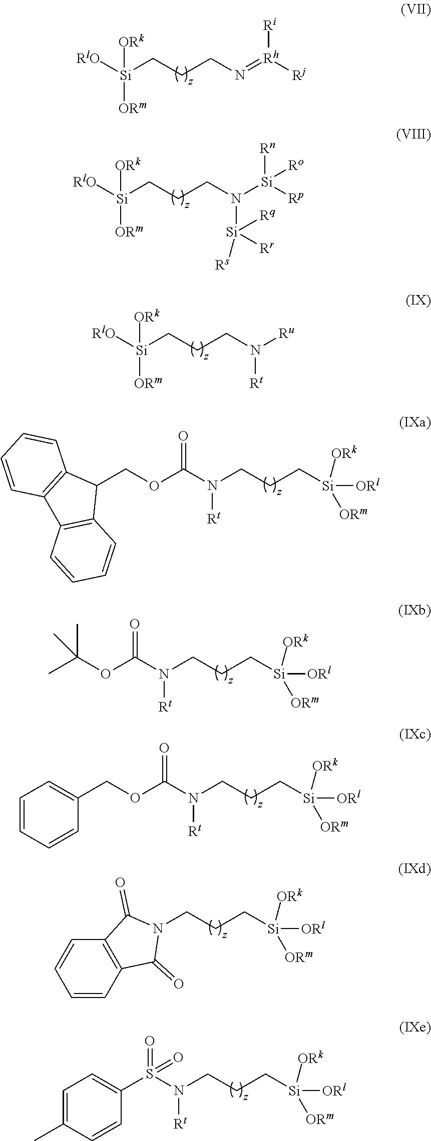

wherein
   R^{h} is C or Si,
   each Rⁱ, R^{j} independently means H, —C(O)R^{t}, an optionally substituted straight-chain or branched C1 to C16 alkyl group, an optionally substituted straight-chain or branched C2 to C16 alkenyl group, or an optionally substituted C4 to C14 aryl group
   each R^{k}, R^{l}, R^{m} independently means H, —C(O)R^{t}, an optionally substituted, straight-chain or branched C1 to C16 alkyl group, an optionally substituted, straight-chain or branched C2 to C16 alkenyl group, or an optionally substituted C4 to C14 aryl group
   each Rⁿ, R^{o}, R^{p}, R^{q}, R^{r}, R^{s} independently means H, —O—R^{t}, —C(O)—R^{t}, —COORt, an optionally substituted, straight-chain or branched C1 to C16 alkyl group, an optionally substituted, straight-chain or branched C2 to C16 alkenyl group, or an optionally substituted C4 to C14 aryl group
   each R^{t}, R^{u} independently means H, —ORⁱ, —C(O)Rⁱ, —C(O)CF₃, —COORⁱ, an optionally substituted straight-chain or branched C1 to C16 alkyl group, an optionally substituted straight-chain or branched C2 to C16 alkenyl group, an optionally substituted C4 to C14 aryl group, or a protecting group in particular a tert-butoxycarbonyl group, a fluorenylmethoxycarbonyl group, a benzyloxycarbonyl group, an allyloxycarbonyl group, an optionally substituted isoindole-1,3-dione group or a 3-methyl-benzenesulfone group, and
   z is an integer from 1 to 30

As mentioned above, the composition may contain certain organosilanes, especially heterocyclic organosilanes in combination with crosslinkers that have malodorous leaving groups. The heterocyclic organosilanes used here can act as adhesion promoters and preferably as stabilizers or silyl transfer reagents.

Therefore, the composition according to the invention contains in a preferred embodiment of the invention
a. a curing agent for silicone rubber masses comprising a compound having the general structural formula R¹ₘSi(R)₄₋ₘ,
   wherein
   each R¹ independently represents an optionally substituted straight-chain or branched C1 to C16 alkyl group, an optionally substituted straight-chain or branched C2 to C16 alkenyl group or an optionally substituted C4 to C14 aryl group,
   m is an integer from 0 to 2,
   each R is independently selected from the group consisting of
      —O—N═CR¹⁰R¹¹, wherein R¹⁰ and R¹¹ independently mean H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group, and
b. at least one heterocyclic organosilane with the following general structural formulae

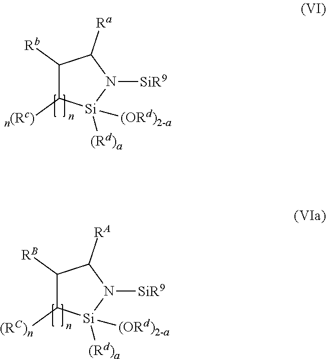

wherein a in (R^{d})ₐ or (R^{d1})ₐ means the ratio of alkoxy radicals to radicals R^{d} and is defined as herein. The ring atoms in the structural formulae (VI) and (VIa) may independently carry different radicals R^{a}, R^{b}, R^{c}, R^{d} or R^{g}, which are defined as herein.

It has been shown that sealants with particularly advantageous properties are obtained when, in a preferred embodiment of the invention, the radicals R⁹ in structural formulae (VI) and (VIa) are selected from the group consisting of an optionally substituted, straight-chain or branched C1 to C6 alkyl group, an optionally substituted, straight-chain or branched C2 to C6 alkenyl group, an optionally substituted C3 to C6 cycloalkyl group, an optionally substituted C4 to C6 cycloalkenyl group, an optionally substituted, straight-chain branched or cyclic C4 to C8 alkynyl group, an optionally substituted straight-chain or branched C1 to C6 heteroalkyl group, an optionally substituted straight-chain, branched or cyclic C2 to C6 heteroalkenyl group or an optionally substituted C4 to C6 aryl or heteroaryl group, preferably consisting of a straight-chain or branched C1 to C6 alkyl group, a straight-chain or branched C2 to C6 alkenyl group, a C5- to C6-cycloalkyl group or a C5- to C6-aryl or heteroaryl group, particularly preferably consisting of methyl, ethyl, propyl, iso-propyl, n-butyl, iso-butyl, ethenyl, propenyl, butenyl, cyclopentyl, cyclohexyl, cyclopentadienyl or phenyl.

The ring size of the heterocyclic organosilanes is determined by the parameter n in the structures, where n can take values between 0 and 6.

The residues (R^{c})ₙ of the structural formula (VI) and (R^{C})ₙ of the structural formula (VIa) are directly related to the ring size, which is determined by the parameter n. The possible number of residues on the ring atoms is also adjusted here by the value n. For example, if there is a 6-membered ring, then n is 2 and the number of residues R^{c} or R^{C} is adjusted to 2. Thus, each ring atom can carry one residue.

Compositions containing the above organosilanes, especially heterocyclic organosilanes, have good properties such as increased storage stability. In particular, this composition shows excellent adhesion to various substrates, preferred substrates are for example glass, aluminum, PVC, sheet metal, steel, concrete, wood, painted wood, glazed wood, polyamide, Al/Mg alloy, polystyrene and Metzoplast, preferred substrates are PVC, polyamide, polystyrene and Metzoplast, especially preferred are polystyrene and Metzoplast.

According to a preferred embodiment of the invention, the further rings of the heterocyclic organosilanes of the general structural formula (VIa) just described, contain at least one heteroatom, such as Si, N, P, S or O in the compositions according to the invention, preferably Si, N or S.

In an embodiment of the invention, the compositions may also contain heterocyclic organosilanes with the following structural formula:

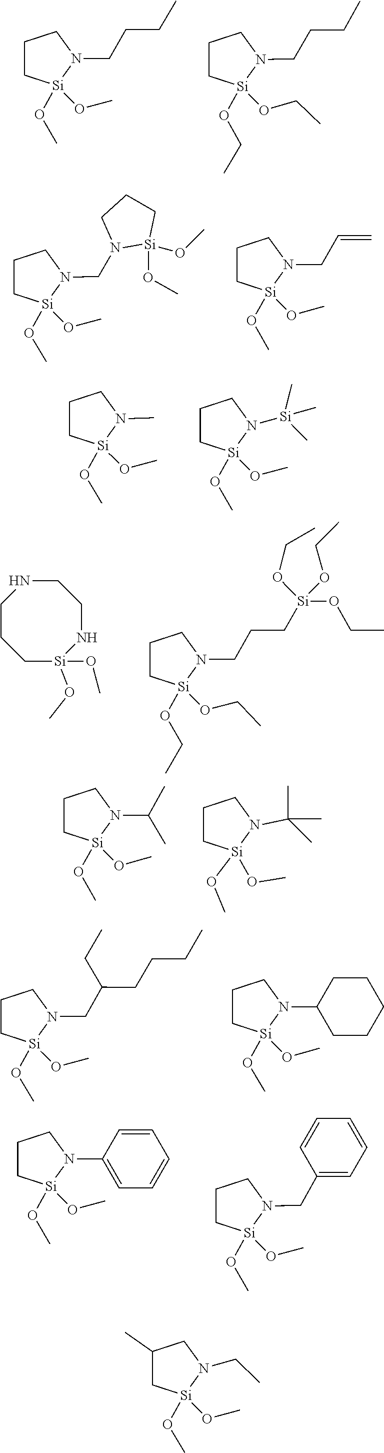

According to a further embodiment of the invention, the composition contains at least two heterocyclic organosilanes, wherein the heterocyclic organosilanes may be defined as described herein.

Compositions containing at least one further organosilane, in particular a cyclic organosilane as described above, are characterized in particular by good stability, especially when stored at higher temperatures.

The composition according to the invention contains a curing agent comprising a compound with the general structural formula R¹ₘSi(R)₄₋ₘ, where m can be an integer from 0 to 2. The compound with the general structural formula R¹ₘSi(R)₄₋ₘ is in particular also referred to as silane. Thus, the curing agent may contain a silane that has two, three or four hydrolysable groups. Preferably m is 0 or 1, so that the curing agent contains a silane with three or four hydrolysable groups. In this way, the degree of crosslinking of the curing agent can be controlled and the solvent resistance and/or mechanical properties of silicone rubber masses can be adjusted.

In case m is not 0 in the general structural formula R¹ₘSi(R)₄₋ₘ, i.e. the silane does not contain four hydrolyzable groups R, another radical R¹ may preferably be present.

If m is 1, the silane can therefore contain three hydrolysable groups and a radical R¹.

In the general structural formula R¹ₘSi(R)₄₋ₘ, m can also be 2. Thus, the general structural formula has two residues R¹. The residues R¹ can be the same or different from each other. By choosing the radicals R¹, the speed of the cross-linking can be controlled.

According to one embodiment of the invention, the composition according to the invention contains oligomers or polymers of the curing agent or the curing agent consists of these. Oligomers and polymers of the curing agent can in particular be at least two compounds with the general structural formula R¹ₘSi(R)₄₋ₘ, in which at least two silicon atoms of the different monomers are connected to each other via siloxane oxygens. The number of radicals R is reduced according to the number of connecting siloxane oxygens at the silicon atom.

For example, in compositions according to the invention, exchange reactions between the groups R of the different curing agents can occur. In particular, these exchange reactions can take place up to a state of equilibrium. This process can also be described as equilibration.

The exchange reactions described above, especially the equilibration, can also take place in particular with suitable groups R^{Au} of other silanes contained in the composition according to the invention. Groups R^{Au} suitable for exchange reactions are, for example, alkoxy, carboxylate, lactate, salicylate, amide, amine, and oxime groups, to name a few. Accordingly, in particular the groups R^{Au} of silanes of the type (R^{In})_{z}Si(R^{Au})_{4-z} can undergo exchange reactions with the groups R of the curing agent, whereby the groups R^{In} do not undergo exchange reactions and z is an integer from 0 to 3. Accordingly, the exchange reactions can distribute the various suitable groups R and R^{Au}, if present, to the corresponding silane compounds contained in a composition according to the invention, in particular contained in a silicone rubber composition, wherein in particular a state of equilibrium can be established.

According to a preferred embodiment of the invention, in the general structural formula R¹ₘSi(R)₄₋ₘ each R¹ independently represents methyl, ethyl, propyl, vinyl, phenyl or allyl residues. Practical tests have shown that curing agents containing such residues yield sealants with good mechanical properties. Furthermore, sealants containing curing agents with such residues can be colorless and transparent.

In the general structural formula R¹ₘSi(R)₄₋ₘ, R can be a hydroxycarboxylic acid ester residue with the general structural formula (I) described herein.

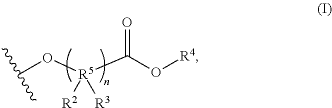

According to one embodiment, in this hydroxycarboxylic acid ester residue each R² and R³ independently of the other represents H or methyl, ethyl, propyl, isopropyl, butyl, n-butyl, sec-butyl, iso-butyl and tert-butyl. Particularly preferred in the hydroxycarboxylic acid ester residue is each R² and R³ selected from the group consisting of H and methyl. Where n is an integer greater than or equal to 1, R² and R³ may be different for each carbon atom of the chain independently of each other. Compositions containing a curing agent containing such compounds may in particular exhibit a pleasant odour and/or be readily compoundable.

According to another version, R⁴ in the hydroxycarboxylic acid ester residue is selected from the group consisting of phenyl, tolyl, naphthyl, benzyl, cyclohexyl, methyl, ethyl, propyl, isopropyl, butyl, n-butyl, sec-butyl, iso-butyl, tert-butyl, pentyl, n-pentyl, sec-pentyl, 3-pentyl, 2-methylbutyl, iso-pentyl, 3-methylbut-2-yl, 2-methylbut-2-yl, neopentyl, hexyl, heptyl, octyl, ethylhexyl, and 2-ethylhexyl.

Compositions containing a curing agent that contain such compounds result in sealants with good mechanical properties. Furthermore, they can be compounded well. The resulting sealants can still be transparent and colorless.

As described above, the aromatic group, for example, has two hydrogen atoms removed, in whose place the ester group and the alcohol function are bonded, thus enabling incorporation into the general structural formula (I).

R⁵ can also mean C and each R² and R³ can mean H. Furthermore, R⁵ can also mean C and R² can be H and R³ can mean methyl-. In the case that in the hydroxycarboxylic acid ester residue R⁵ is C and n is an integer greater than 1, R² and R³ may be different for each carbon atom of the chain independently of each other.

According to a preferred embodiment of the invention, in the hydroxycarboxylic acid ester residue n is an integer from 1 to 5, preferably from 1 to 3, in particular 1.

According to a further embodiment of the invention, in the general structural formula R¹ₘSi(R)₄₋ₘR is selected from the group consisting of a glycolic acid ester residue, a lactic acid ester residue and a salicylic acid ester residue, wherein R⁴ is in each case an optionally substituted, straight-chain or branched C1 to C16 alkyl group, in particular an optionally substituted, straight-chain or branched C1 to C12 or C1 to C8 alkyl group, a C4 to C14 cycloalkyl group, in particular a C4 to C10 cycloalkyl group, a C5 to C15 aralkyl group, in particular a C5 to C11 aralkyl group, or a C4 to C14 aryl group, in particular a C4 to C10 aryl group Here, R⁴ is in particular selected from the group consisting of phenyl, tolyl, naphthyl, benzyl, cyclohexyl, methyl, ethyl, propyl, isopropyl, butyl, n-butyl, sec-butyl, iso-butyl, and tert-butyl, pentyl, n-pentyl, sec-pentyl, 3-pentyl, 2-methylbutyl, iso-pentyl, 3-methylbut-2-yl, 2-methylbut-2-yl, neopentyl, hexyl, heptyl, octyl, ethylhexyl, and 2-ethylhexyl.

Practical tests have shown that compositions containing such compounds result in sealants with good mechanical properties. Furthermore, compositions containing such compounds have a pleasant odour, as they release substances with a pleasant odour during hydrolysis. Furthermore, sealants containing such curing agents can be transparent and colorless.

According to a particularly preferred embodiment of the invention, the curing agent in the composition is selected from the group consisting of tris(methyllactato)vinylsilane, tris(ethyllactato)vinylsilane, tris(ethylhexyllactato)vinylsilane, tris(methylsalicylato)vinylsilane, tris(ethylsalicylato)vinylsilane, tris(ethylhexylsalicylato)vinylsilane, tris(2-ethylhexylsalicylato)vinylsilane, tris(isopropylsalicylato)vinylsilane, tris(methyllactato)methylsilane, tris(ethyllactato)methylsilane, tris(ethylhexyllactato)methylsilane, tris(methylsalicylato)methylsilane, tris(ethylsalicylato)methylsilane, tris(ethylhexylsalicylato)methylsilane, tris(2-ethylhexylsalicylato)methylsilane, tris(3-aminopropyl)methylsilane, tris(5-aminopentyl)methylsilane, tris(methyllactato)propylsilane, tris(ethyllactato)propylsilane, tris(ethylhexyllactato)propylsilane, tris(ethylsalicylato)-propylsilane, tris(ethylhexylsalicylato)propylsilane, tris(2-ethylhexylsalicylato)propylsilane, tris(isopropylsalicylato)propylsilane, tris(3-aminopropyl)propylsilane, tris(5-aminopentyl)-propylsilane, tris(methyllactato)ethylsilane, tris(ethyllactato)ethylsilane, tris(ethylhexyllactato)ethylsilane, tris(methylsalicylato)-ethylsilane, tris(ethylsalicylato)-ethylsilane, tris(ethylhexylsalicylato)ethylsilane, tris(2-ethylhexylsalicylato)ethylsilane, tris(isopropylsalicylato)ethylsilane, tris(3-aminopropyl)ethylsilane, tris(5-aminopentyl)ethylsilane, tris(methyllactato)phenylsilane, tris(ethyllactato)phenylsilane, tris-(ethylhexyllactato)phenylsilane, tris(methylsalicylato)phenylsilane, tris(ethylsalicylato)phenylsilane, tris(ethylhexylsalicylato)phenylsilane, tris(2-ethylhexylsalicylato)phenylsilane, tris(isopropylsalicylato)phenylsilane, tris(3-aminopropyl)phenylsilane, tris(5-aminopentyl)phenylsilane, tetra(methyllactato)silane, tetra(ethyllactato)silane, tetra(ethylhexyllactato)silane, tetra(ethylhexylsalicylato)silane, tetra(2-ethylhexylsalicylato)silane, tetra(methylsalicylato)silane, tetra(isopropylsalicylato)silane, tetra(ethylsalicylato)silane, tetra(3-aminopropyl)silane, tetra(5-aminopentyl)silane and mixtures thereof.

In addition to the compound with the general structural formula R¹ₘSi(R)₄₋ₘ, the curing agent may additionally contain a compound with the general structural formula R¹²ₒSi(R)₄₋ₒ, wherein each R¹² independently of the other represents an optionally substituted, straight-chain or branched C1 to C16 alkyl group, in particular an optionally substituted, straight-chain or branched C1 to C12 or a C1 to C8 alkyl group or a methyl or propyl group, or an optionally substituted, straight-chain or branched C2- to C16-alkenyl group, in particular an optionally substituted, straight-chain or branched C2- to C12- or a C2- to C8-alkenyl group or a vinyl group or an optionally substituted C4- to C14-aryl group or a phenyl group and R is defined according to one of claims 1, 15 or 21 and o is an integer from 0 to 2 and wherein R¹ₘSi(R)₄₋ₘ and R¹²ₒSi(R)₄₋ₒ cannot be the same.

In a further embodiment, the composition is obtainable by mixing at least one curing agent, which is defined as herein or a mixture of curing agents as described above, with an organosilane of the invention, in particular a heterocyclic organosilane, which is defined as herein.

For example, the composition according to the invention may contain a combination of tris(2-ethylhexylsalicylato)vinylsilane and/or tris(2-ethylhexylsalicylato)methylsilane as curing agent and 2,2-dimethoxy-1-(n-butyl)aza-2-silacyclopentane (BDC) and/or 2,2-diethoxy-1-(trimethylsilyl)aza-2-silacyclopentane (TMS-DEC) as heterocyclic organosilane.

Furthermore, the composition according to the invention can contain a combination of vinyl tris(ethyllactato)silane and/or methyl tris(ethyllactato)silane as curing agent and 2,2-dimethoxy-1-(n-butyl)aza-2-silacyclopentane (BDC) and/or 2,2-diethoxy-1-(trimethylsilyl)aza-2-silacyclopentane (TMS-DEC) as heterocyclic organosilane.

Furthermore, the composition according to the invention can contain a combination of vinyl tris(ethyllactato)silane and/or methyl tris(ethyllactato)silane as curing agent and 2,2-dimethoxy-1-(methyl)aza-2-silacyclopentane (MDC) and/or 2,2-diethoxy-1-(3-triethoxysilylpropyl)aza-2-silacyclopentane (TESPDC) heterocyclic organosilane.

Furthermore, the composition according to the invention can contain a combination of vinyl-tris(ethyllactato)silane and/or methyl-tris(ethyllactato)silane as curing agent and 2,2-dimethoxy-1-(phenyl)aza-2-silacyclopentane (Ph-DC) and/or 2,2-dimethoxy-1-(methyl)aza-2-silacyclopentane (MDC) as heterocyclic organosilane.

The composition according to the invention can also contain a combination of tris(ethylsalicylato)vinylsilane and/or tris(ethylsalicylato)propylsilane as curing agent and 2,2-diethoxy-1-(benzyl)aza-2-silacyclopentane (Bn-DEC) and/or 2,2-dimethoxy-1-(benzyl)aza-2-silacyclopentane (Bn-DC) as heterocyclic organosilane.

Furthermore, the composition according to the invention can contain a combination of vinyl tris(ethyllactato)silane and/or methyl tris(ethyllactato)silane as curing agent and 2,2-diethoxy-1-(benzyl)aza-2-silacyclopentane (Bn-DEC) and/or 2,2-diethoxy-1-(3-triethoxysilylpropyl)aza-2-silacyclopentane (TESPDC) as heterocyclic organosilane.

Furthermore, the composition according to the invention can contain a combination of vinyl tris(ethyllactato)silane and/or methyl tris(ethyllactato)silane as curing agent and 2,2-diethoxy-1-(phenyl)aza-2-silacyclopentane (Ph-DEC) and/or 2,2-diethoxy-1-(trimethylsilyl)aza-2-silacyclopentane (TMS-DEC) as heterocyclic organosilane.

Furthermore, the composition according to the invention can contain a combination of vinyl-tris(ethyllactato)silane and/or methyl-tris(ethyllactato)silane as curing agent and 2,2-dimethoxy-1-(trimethylsilyl)aza-2-silacyclopentane (TMS-DC) and/or 2,2-dimethoxy-1-(methyl)aza-2-silacyclopentane (MDC) as heterocyclic organosilane.

It has been shown that such combinations of curing agents and adhesion promoters can have positive properties for sealant formulations. On the one hand, the reactivity of the amino function in the heterocyclic organosilanes is reduced in such a way that an amidation reaction between silanes, especially silane crosslinkers, and the cyclic adhesion promoters is made more difficult or preferably completely prevented. On the other hand, the crosslinkers and adhesion promoters are hardly or preferably not consumed. The organosilanes, especially the heterocyclic organosilanes, can be combined with different types of crosslinkers, such as α-hydroxycarboxylic acid derivatives, α-hydroxycarboxylic acid amides or oxime derivatives. The leaving groups also have a pleasant odour, which can be further improved preferably by adding special silyl transfer reagents, such as 2,2-diethoxy-1-(trimethylsilyl)aza-2-silacyclopentane (TMS-DEC) or 2,2-diethoxy-1-(3-triethoxysilylpropyl)aza-2-silacyclopenta (TESPDC). Furthermore, the organosilanes, especially the heterocyclic organosilanes, are suitable as scavenging reagents for water, alcohols or hydroxide ions. This improves the long-term stability during storage of the sealant compounds. It was also found that such combinations in sealants lead to good mechanical properties of the sealants. In addition, these combinations are suitable for use on a wide range of substrates, including attackable substrates such as metals, marble or mortar. In particular, the sealants according to the invention show good adhesion to plastic substrates such as polystyrene and Metzoplast.

According to a further embodiment of the invention, a composition according to the invention comprises, in addition to the above described components curing agent and adhesion promoter or first curing agent, second curing agent and adhesion promoter, at least one organopolysiloxane compound, preferably two, three or more different organopolysiloxane compounds. An organosilicone compound contained in the composition is preferably an oligomeric or polymeric compound as defined herein.

Within the meaning of the invention, the curable compositions can optionally be modified with respect to their properties by adding conventional additives, such as plasticizers, fillers, colorants, thixotropic agents, wetting agents or UV stabilizers.

Polyalkylsiloxanes, especially polydimethylsiloxane, are used as plasticizers in a preferred embodiment.

In another preferred embodiment, silicic acid is added to the curable composition as a filler, particularly preferred fumed silica also known as fumed silica.

Aminoalkyltrialkoxysilanes are preferred thixotropic agents. The aminopropyltriethoxysilane provides compositions with particularly advantageous properties and is therefore preferred.

As plasticizers, compounds can be used which are defined as herein. In a particularly preferred embodiment, known polydiorganosiloxanes without functional end groups and/or liquid aliphatic or aromatic hydrocarbons have proved particularly advantageous, preferably those with molecular weights of about 50 to about 5000, whose volatility is low and which are sufficiently compatible with polysiloxanes. Polydialkylsiloxanes without functional end groups are particularly preferred, most preferably a polydi —C₁₋₆— alkylsiloxane without functional end groups and most preferably a polydimethylsiloxane without functional end groups.

The compositions according to the invention can crosslink in the presence of moisture. In the process, they cure with the formation of Si—O—Si bonds. The curing of the compositions can be accelerated by adding a suitable catalyst.

Therefore, the composition preferably still contains at least one catalyst. Organometallic catalysts can be used, such as those normally used for condensation-curing polysiloxanes. Examples of catalysts are tin carboxylates, titanium, zirconium or aluminum compounds. In particular, compounds consisting of titanium silsesquioxanes (Ti-POSS), dibutyl tin dilaurate, dibutyl tin divaleriate, dibutyl tin diacetate are preferred, dibutyl tin dineodecanoate, dibutyl tin diacetylacetonate, dioctyl tin bis(2-ethylhexanoate), dibutyl tin dimaleate, tin(II) octoate and butyl tin tris(2-ethylhexanoate). Particularly preferred catalysts are (iBu)₇Si₇O₁₂TiOEt, (C₃H₁₇)₇Si₇O₁₂TiOEt, dibutyltin dilaurate, dibutyltin diacetate and/or tin(II) octoate.

It has been found that the composition can be stored in the absence of moisture for periods of more than 9 months and up to more than 12 months and still cross-links under the influence of water or humidity at room temperature.

The composition according to the invention may comprise 30 to 70 wt. % of α, ω-dihydroxydialkyl organopolysiloxane, 1 to 10 wt.-% of the curing agent and 0.1 to 10 wt.-% of the organosilane, in particular heterocyclic organosilane, each based on the total weight of the composition according to the invention.

The composition according to the invention preferably contains 30 to 70 wt.-% of α, ω-dihydroxydialkylorganopolysiloxane, 1 to 10 wt.-% of the curing agent, 0.1 to 10 wt.-% organosilane, in particular heterocyclic organosilane, 20 to 50 wt.-% plasticizer, 1 to 20 wt.-% filler and 0.01 to 1 wt.-% catalyst, each based on the total weight of the composition according to the invention.

Furthermore, the composition according to the invention can comprise 40 to 60 wt.-% α, ω-dihydroxydialkylorganopolysiloxane, 3 to 7 wt.-% of the curing agent, 0.5 to 2.5 wt.-% organosilane, in particular heterocyclic organosilane, 25 to 40 wt.-% plasticizer, 5 to 15 wt.-% filler and 0.05 to 0.5 wt.-% catalyst, in each case based on the total weight of the composition according to the invention.

Likewise, the organosilane, especially heterocyclic organosilane in a preferred embodiment, can be used as water scavenger, alcohol scavenger and/or hydroxide ion scavenger. The organosilanes, especially heterocyclic organosilanes, can thus have a positive effect on the storage stability of the compositions, especially before discharge.

After discharge of the compositions according to the invention, the organosilane, especially heterocyclic organosilane, may react with the existing air humidity and/or water. Preferably, after alcoholysis and/or hydrolysis of the organosilanes, especially heterocyclic organosilanes, compounds are formed which can act as adhesion promoters.

Accordingly, in a particularly preferred embodiment of the invention, the reaction product of at least one organosilane, in particular heterocyclic organosilane with water, hydroxide ions, alcohols or mixtures thereof, is used as an adhesion promoter.

The compositions according to the invention are particularly suitable for use in the manufacture of a silicone rubber mass.

The composition is preferably used in the building industry as a sealant or as an adhesive, potting compound or coating agent. In particular, it is used for joints in structural and civil engineering, glass and window construction and in the sanitary sector. Other uses are in mechanical engineering, e.g. in the automotive industry (preferred), the electrical industry, the textile industry or in industrial plant construction.

In the following, the invention is illustrated by specific, non-limiting examples.

### EXAMPLES

Adhesion Promoter Synthesis

Some heterocyclic organosilanes are commercially available compounds such as N-n-butyl-aza-2,2-dimethoxysilacyclopentane ((BDC), CAS No. 618914-44-6), 2,2-diethoxy-1-(3-triethoxysilylpropyl)aza-2-silacyclopentane ((TESPDC), CAS No. 1184179-50-7) or 2,2-diethoxy-1-(trimethylsilyl)aza-2-silacyclopentane ((TMS)DEC), CAS No. 21297-72-3).

However, heterocyclic organosilanes are preferably produced synthetically from the non-cyclic precursor molecules. In principle, the synthesis is already known in the prior art and is exemplified by the preparation of a sila-aza-cyclopentane (BDC)

### Example 1

### Synthesis of (BDC)

In a 500 mL triple-necked flask with paddle stirrer and reflux condenser, 100.40 g (105.70 mL, 0.43 mol) butylaminopropyltrimethoxysilane (BAPTMS) with 2 g ammonium sulfate (1.13 mL, 0.015 mol) are added under nitrogen atmosphere and slowly heated to boiling point (100° C.) while stirring and kept at this temperature for 8 h. Removal of the volatile reaction components at 100° C. and 25 mbar yields 52.5 g (0.26 mol, 60%) of the product N-n-butyl-aza-2,2-dimethoxysilacyclopentane (BDC) as pale yellow liquid.

Sealant Formulations

Further sealant formulations were produced and tested.

In the case of the examples described below, all parameters were determined using the test procedures described below. All sealants described below were transparent and colorless and exhibited a pleasant odor as well as proper stability and notch resistance after 24 hours. Furthermore, the following sealants passed all three test specimens according to DIN EN ISO 8340 climatic method A on glass at an elongation of 100% of the initial length, wherein the elongation was maintained for 24 h.

The product properties skin formation time, tack-free time, through-curing and elongation at break of the silicone rubber masses (sealant formulations) were determined after application of the sealants using the test methods described below. Unless otherwise stated, the measurements were performed at 23° C. and 50% humidity.

The skin formation time indicates the time at which a complete layer of solidified material (skin) was observed on the surface of a sample strand after application of the sealant. The tack-free time indicates the time at which the surface of a sample strand no longer exhibits tack. To determine the complete curing, the sealant is applied to a glass plate at a height of 9 mm and the time taken to cure through to the glass plate is measured. The elongation at break was determined according to DIN EN ISO 8339:2005-09.

### Example 2

### Lactate Crosslinker Mixture with 2,2-dimethoxy-1-(n-butyl)aza-2-silacyclopentane (BDC)

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 32.9 |
| 3 | Crosslinker 1: Vinyl-tris(ethyllactato)silane | 2.5 |
| 4 | Crosslinker 2: Methyl-tris(ethyllactato)silane | 2.5 |
| 5 | Aminopropyltriethoxysilane (AMEO) | 0.2 |
| 6 | Pyrogenic silica, untreated | 8.5 |
| | BET surface 130-150 m2/g | |
| 7 | Catalyst 1:1 (w/w) Mixture of dialkyl zinc | 0.1 |
| | oxide and tetraalkoxysilane | |
| 8 | Adhesion promoter: 2,2-dimethoxy-1-(n- | 1.2 |
| | butyl)aza-2-silacyclopentane (BDC) | |

α,ω-dihydroxy-dimethyl-polysiloxane 80,000 cSt, PDMS 100 cSt, vinyl-tris(ethyllactato)silane and methyl-tris(ethyllactato)silane were mixed under vacuum. AMEO was then mixed in as a thixotropic agent. The silica was then dispersed and stirred under vacuum until the mass was smooth. Finally, the catalyst as a 1:1 (w/w) mixture of dialkyl zinc oxide and tetraalkoxysilane and the adhesion promoter 2,2-dimethoxy-1-(n-butyl)aza-2-silacyclopentane (BOO) were mixed in under vacuum.

The product was transparent and colorless. It was characterized by a skin formation time of 6 minutes and a tack-free time of 100 minutes. The composition had good adhesion on all tested materials, i.e. glass, aluminum, PVC, sheet metal, steel, concrete, wood, wood varnished, wood glazed, polyamide, polystyrene, Metzoplast and Al/Mg alloy and had a pleasant odor. The determined Shore A cureness was 27. Even after 6 weeks storage at 50° C., the sealant was stable after curing (Shore A:18) and showed only a slightly yellowish coloration, wherein the resulting sealant was colorless again after exposure to light. The extrusion when using a 2 mm diameter die at 5 bar and 30 seconds was 24.0 g. Furthermore, the sealant showed excellent properties:

| Property | Sealant |
|---|---|
| Early resilience | 105 min |
| Through curing on glass (9 | 4 d |
| mm) | |
| DIN EN ISO 8339 | 0.26 |
| Elongation stress value at | |
| 100% elongation (N/mm2) | |
| DIN EN ISO 8339 | 0.42 |
| Secant modulus at | |
| elongation at break (N/mm2) | |
| DIN EN ISO 8339 | 285% |
| Elongation at break | |
| DIN EN ISO 7389 | 93% |
| Average resilience | |
| DIN 53504 | 0.98 |
| Tear resistance (N/mm2) | |
| DIN 53504 | 1050% |
| Elongation at break | |

### Example 3

### Lactate Crosslinker Mixture with 2,2-diethoxy-1-(trimethylsilyl)aza-2-silacyclopentane (TMS-DEC)

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 32.4 |
| 3 | Crosslinker 1: Vinyl-tris(ethyllactato)silane | 0.8 |
| 4 | Crosslinker 2: Methy-ltris(ethyllactato) | 3.2 |
| | silane | |
| 5 | Aminopropyltriethoxysilane (AMEO) | 0.2 |
| 6 | Pyrogenic silica, hydrophobic | 10.0 |
| | BET surface 130-150 m2/g | |
| 7 | Catalyst 1:1 (w/w) Mixture of dialkyl zinc | 0.1 |
| | oxide and tetraalkoxysilane | |
| 8 | Adhesion promoter: 2,2-diethoxy-1- | 1.2 |
| | (trimethylsilyl)aza-2-silacyclopentane | |
| | (TMS-DEC) | |

Polymer 80,000 cSt, PDMS 100 cSt and the crosslinker mixture of vinyl-tris(ethyllactato)silane and methyl-tris(ethyllactato)silane were mixed under vacuum. The thixotropic agent AMEO was then added under vacuum. The silica was then dispersed and stirred under vacuum until the mass was smooth. The catalyst was then mixed in as a 1:1 (w/w) mixture of dialkyl zinc oxide and tetraalkoxysilane and the adhesion promoter 2,2-diethoxy-1-(trimethylsilyl)aza-2-silacyclopentane (TMS-DEC) under vacuum.

The product was transparent and colorless. It was characterized by a skin formation time of 17 minutes and a tack-free time of 33 minutes. The resulting sealant had good adhesion to all tested materials, i.e. glass, aluminum, PVC, sheet metal, steel, concrete, wood, wood varnished, wood glazed, polyamide, Al/Mg alloy, polystyrene and Metzoplast and had a pleasant odor.

The determined Shore A cureness was 22. Even after 8 weeks storage at 60° C., the sealant was stable (Shore A:16) and only showed a slightly yellowish coloration. Extrusion using a 2 mm diameter die at 5 bar and 30 seconds was 31.0 g, and the sealant was transparent and colorless again after exposure to light. The sealant was also characterized by the following excellent properties:

| Property | Sealant |
|---|---|
| Early resilience | 105 min |
| Through curing on glass | 6 d |
| (9 mm) | |
| DIN EN ISO 8339 | 0.24 |
| Elongation stress value at | |
| 100% elongation (N/mm2) | |
| DIN EN ISO 8339 | 0.45 |
| Secant modulus at | |
| elongation at break (N/mm2) | |
| DIN EN ISO 8339 | 470% |
| Elongation at break | |
| DIN EN ISO 7389 | 93% |
| Average resilience | |
| DIN 53504 | 0.61 |
| Tear resistance (N/mm2) | |
| DIN 53504 | 830% |
| Elongation at break | |

### Comparison of the Storage Stability when Using Adhesion Promoters According to the Invention (Examples 4 and 5) with Conventional Adhesion Promoters (Comparative Example)

In the case of the sealant formulations from the following examples 4 and 5 and the comparison example, silicone rubber masses are each produced with the following formulation:

| | |
|---|---|
| 521 g | Alpha,omega-dihydroxyl terminated |
| | polydimethylsiloxane with viscosity 80,000 cSt |
| 324 g | Polydimethylsiloxane with viscosity 100 cSt |
| 8 g | Crosslinker 1: Vinyl-tris(ethyllactato)silane |
| 32 g | Crosslinker 2: Methyl-tris(ethyllactato)silane |
| 2 g | Aminoalkyltrialkoxysilane (AMEO) |
| 100 g | Pyrogenic silica |
| 1 g | Catalyst 1:1 (w/w) Mixture of dialkyl zinc |
| | oxide and tetraalkoxysilane |

### Example 4

The following adhesion promoter was added to the sealant formulation:

| | |
|---|---|
| 12 g | Adhesion promoter: 2,2-dimethoxy-1-(methyl)aza-2- |
| | silacyclopentane (MDC) |

-Dihydroxy-dimethyl-polysiloxane 80,000 cSt, PDMS 100 cSt, vinyl-tris(ethyllactato)silane and methyl-tris(ethyllactato)silane were mixed under vacuum. The silica was then dispersed and stirred under vacuum until the mass was smooth. Then AMEO was mixed in as a thixotropic agent. The silica was then dispersed and stirred under vacuum until the mass was smooth. Finally, the catalyst as a 1:1 (w/w) mixture of dialkyl zinc oxide and tetraalkoxysilane and the adhesion promoter 2,2-dimethoxy-1-(methyl)aza-2-silacyclopentane (MDC) are mixed in under vacuum.

The resulting sealant was transparent and colorless and had a skin formation time of 5 minutes, a tack-free time of 9 minutes and a curing time on glass (sealant applied 9 mm thick on a glass plate) of 6 days. The sealant had good adhesion on all tested materials, i.e. glass, aluminum, PVC, sheet metal, steel, concrete, wood, wood varnished, wood glazed, polyamide, Al/Mg alloy, polystyrene and Metzoplast and had a pleasant odor. The determination of the tensile strength according to DIN 53504 was 1.1 N/mm² and the elongation at break according to DIN 53504 was determined to 1100%. The determined Shore A cureness was 27. Even after storing the sealant at 50° C. for 8 weeks, the sealant was stable (Shore A: 17) and showed only a slight, slightly yellowish discoloration. After application, the sealant becomes colorless again when exposed to light.

### Example 5

Adhesion Promoter pH-DEC

| | |
|---|---|
| 12 g | Adhesion promoter: 2,2-diethoxy-1-(phenyl)aza-2- |
| | silacyclopentane (Ph-DEC) |

α,ω-dihydroxy-dimethyl-polysiloxane 80,000 cSt, PDMS 100 cSt, vinyl-tris(ethyllactato)silane and methyl-tris(ethyllactato)silane were mixed under vacuum. The silica was then dispersed and stirred under vacuum until the mass was smooth. Then AMEO was mixed in as a thixotropic agent. The silica was then dispersed and stirred under vacuum until the mass was smooth. Finally, the catalyst as a 1:1 (w/w) mixture of dialkyl zinc oxide and tetraalkoxysilane and the adhesion promoter 2,2-diethoxy-1-(phenyl)aza-2-silacyclopentane (Ph-DEC) are mixed in under vacuum.

The resulting sealant was transparent and colorless and had a skin formation time of 70 minutes, a tack-free time of 24 h and a curing time on glass (sealant applied 9 mm thick on a glass plate) of 7 days. The sealant had good adhesion on all tested materials, i.e. glass, aluminum, PVC, sheet metal, steel, concrete, wood, wood varnished, wood glazed, polyamide, Al/Mg alloy, polystyrene and Metzoplast and had a pleasant odor. The determined Shore A cureness was 25. After storing the sealant at 50° C. for 8 weeks, the sealant was stable (Shore A: 16) and showed only a slight, slightly yellowish discoloration.

### Comparative Example (Prior Art; Based on EP2030976 A1, Example 7)

### Adhesion Promoter from Example 7

| | |
|---|---|
| 12 g | Adhesion promoter: Aminoalkyltrialkoxysilane [AMEO] |

The resulting sealant has a transparent appearance after application in air and had a skin formation time of 5 minutes and a tack-free time of 32 minutes. The sealant showed poor adhesion to glass, aluminum, PVC, sheet metal, steel, wood, painted wood, varnished wood, polyamide, Al/Mg alloy, concrete, polystyrene and Metzoplast. In addition, there was no through-curing on glass (9 mm) and the storage stability at 50° C. was no longer given after only 4 days.

### Example 6

### Lactate Crosslinker Mixture with 2,2-dimethoxy-1-(benzyl)aza-2-silacyclopentane (Bn-DC)

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 32.4 |
| 3 | Crosslinker 1: Vinyl-tris(ethyllactato)silane | 0.8 |
| 4 | Crosslinker 2: Methyl-tris(ethyllactato)silane | 3.2 |
| 5 | Aminopropyltriethoxysilane (AMEO) | 0.2 |
| 6 | Pyrogenic silica, hydrophobic | 10.0 |
| | BET surface 130-150 m2/g | |
| 7 | Catalyst 1:1 (w/w) Mixture of dialkyl zinc | 0.1 |
| | oxide and tetraalkoxysilane | |
| 8 | Adhesion promoter: 2,2-dimethoxy-1- | 1.2 |
| | (benzyl)aza-2-silacyclopentane (Bn-DC) | |

Polymer 80,000 cSt, PDMS 100 cSt and the crosslinker mixture of vinyl-tris(ethyllactato)silane and methyl-tris(ethyllactato)silane were mixed under vacuum. The thixotropic agent AMEO was then mixed in under vacuum. The silica was then dispersed and stirred under vacuum until the mass was smooth. The catalyst was then mixed in as a 1:1 (w/w) mixture of dialkyl zinc oxide and tetraalkoxysilane and the adhesion promoter 2,2-dimethoxy-1-(benzyl)aza-2-silacyclopentane (Bn-DC) under vacuum.

The resulting composition was transparent and colorless after curing. It was characterized by a skin formation time of 18 minutes and a tack-free time of 30 minutes. The resulting sealant had good adhesion on all tested materials, i.e. glass, aluminum, PVC, sheet metal, steel, concrete, wood, wood varnished, wood glazed, polyamide, Al/Mg alloy, polystyrene and Metzoplast and had a pleasant odor.

The Shore A cureness was 23. Even after 8 weeks storage at 50° C., the composition was stable after curing (Shore A:17) and only showed a slightly yellowish coloration. The extrusion when using a 2 mm diameter die at 5 bar and 30 seconds was 30.0 g, and the sealant was transparent and colorless again after exposure to light. The sealant was also characterized by the following excellent properties:

| Property | Sealant |
|---|---|
| Early resilience | 105 min |
| Through curing on glass | 6 d |
| (9 mm) | |
| DIN EN ISO 8339 | 0.29 |
| Elongation stress value at | |
| 100% elongation (N/mm2) | |
| DIN EN ISO 8339 | 0.53 |
| Secant modulus at | |
| elongation at break (N/mm2) | |
| DIN EN ISO 8339 | 335% |
| Elongation at break | |
| DIN EN ISO 7389 | 93% |
| Average resilience | |

### Example 7

### Lactate Crosslinker Mixture with 2,2-dimethoxy-1-(phenyl)aza-2-silacyclopentane (Ph-DC)

A silicone rubber mass was prepared according to the following composition by mixing the components analogous to the already described example formulations under vacuum:

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 32.4 |
| 3 | Crosslinker 1: Vinyl-tris(ethyllactato)silane | 0.8 |
| 4 | Crosslinker 2: Methyl-tris(ethyllactato)silane | 3.2 |
| 5 | Aminopropyltriethoxysilane (AMEO) | 0.2 |
| 6 | Pyrogenic silica, hydrophobic | 10.0 |
| | BET surface 130-150 m2/g | |
| 7 | Catalyst 1:1 (w/w) Mixture of dialkyl zinc | 0.1 |
| | oxide and tetraalkoxysilane | |
| 8 | Adhesion promoter: 2,2-dimethoxy-1- | 1.2 |
| | (phenyl)aza-2-silacyclopentane (Ph-DC) | |

The resulting sealant was transparent and colorless and had a skin formation time of 120 minutes and a tack-free time of 24 h. The resulting sealant had good adhesion to all tested materials, i.e. glass, aluminum, PVC, sheet metal, steel, concrete, wood, painted wood, varnished wood, polyamide, Al/Mg alloy, polystyrene and Metzoplast and had a pleasant odor.

The determined Shore A cureness was 22. Even after 8 weeks storage at 50° C., the composition was stable after curing (Shore A:16) and showed only a slightly yellowish coloration, which changed back to colorless when exposed to light. The extrusion when using a 2 mm diameter die at 5 bar and 30 seconds was 24.0 g. The sealant was characterized by other excellent properties:

| Property | Sealant |
|---|---|
| Early resilience | 280 min |
| Through curing on glass | 7 d |
| (9 mm) | |
| DIN EN ISO 8339 | 0.29 |
| Elongation stress value at | |
| 100% elongation (N/mm2) | |
| DIN EN ISO 8339 | 0.51 |
| Secant modulus at | |
| elongation at break (N/mm2) | |
| DIN EN ISO 8339 | 320% |
| Elongation at break | |
| DIN EN ISO 7389 | 93% |
| Average resilience | |

### Example 8

### Lactate Crosslinker Mixture with 2,2-diethoxy-1-(3-triethoxysilyipropyl)aza-2-silacyclopentane (TESPDC)

A silicone rubber mass was produced according to the following composition by mixing the components analogous to the examples already described under vacuum:

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 32.4 |
| 3 | Crosslinker 1: Vinyl-tris(ethyllactato)silane | 0.8 |
| 4 | Crosslinker 2: Methyl-tris(ethyllactato)silane | 3.2 |
| 5 | Aminopropyltriethoxysilane (AMEO) | 0.2 |
| 6 | Pyrogenic silica, hydrophobic | 10.0 |
| | BET surface 130-150 m2/g | |
| 7 | Catalyst 1:1 (w/w) Mixture of dialkyl zinc | 0.1 |
| | oxide and tetraalkoxysilane | |
| 8 | Adhesion promoter: 2,2-diethoxy-1-(3- | 1.2 |
| | triethoxysilylpropyl)aza-2-silacyclopentane | |
| | (TESPDC) | |

The resulting sealant was transparent and colorless and was characterized by a skin formation time of 6 minutes and a tack-free time of 18 minutes. After curing, the compositions had good adhesion on all tested materials, i.e. glass, aluminum, PVC, sheet metal, steel, concrete, wood, painted wood, varnished wood, polyamide, Al/Mg-alloy, polystyrene and Metzoplast and had a pleasant odor.

The determined Shore A cureness was 29. Even after 8 weeks storage at 50° C., the sealant was stable (Shore A:17) and showed only a slight yellowish coloration, but became colorless again when exposed to light. The extrusion when using a 2 mm diameter die at 5 bar and 30 seconds was 34.0 g. The sealant also had the following excellent properties:

| Property | Sealant |
|---|---|
| Early resilience | 105 min |
| Through curing on glass | 7 d |
| (9 mm) | |
| DIN EN ISO 8339 | 0.33 |
| Elongation stress value at | |
| 100% elongation (N/mm2) | |
| DIN EN ISO 8339 | 0.45 |
| Secant modulus at | |
| elongation at break (N/mm2) | |
| DIN EN ISO 8339 | 270% |
| Elongation at break | |
| DIN EN ISO 7389 | 93% |
| Average resilience | |

### Example 9

### Lactate Crosslinker Mixture with 2,2-diethoxy-1-(benzyl)aza-2-silacyclopentane (Bn-DEC)

A silicone rubber mass was prepared according to the following composition by mixing the components as described above under vacuum:

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 32.4 |
| 3 | Crosslinker 1: Vinyl-tris(ethyllactato)silane | 0.8 |
| 4 | Crosslinker 2: Methyl-tris(ethyllactato)silane | 3.2 |
| 5 | Aminopropyltriethoxysilane (AMEO) | 0.2 |
| 6 | Pyrogenic silica, hydrophobic | 10.0 |
| | BET surface 130-150 m2/g | |
| 7 | Catalyst 1:1 (w/w) Mixture of dialkyl zinc | 0.1 |
| | oxide and tetraalkoxysilane | |
| 8 | Adhesion promoter: 2,2-diethoxy-1- | 1.2 |
| | (benzyl)aza-2-silacyclopentane (Bn-DEC) | |

The product was transparent and colorless and had a skin formation time of 11 minutes and a tack-free time of 21 minutes. It had good adhesion to all tested materials, i.e. glass, aluminum, PVC, sheet metal, steel, concrete, wood, painted wood, varnished wood, wood stained, polyamide, Al/Mg alloy, polystyrene and Metzoplast and had a pleasant odor.

The determined Shore A cureness was 27. Even after 8 weeks storage at 50° C., the sealant was stable (Shore A:16) and showed only a slightly yellowish coloration, whereby the sealant became colorless again when exposed to light. The extrusion when using a 2 mm diameter die at 5 bar and 30 seconds was 30.0 g. The sealant also had an early strength of 100 minutes. The curing time on glass was determined to 7 days.

### Example 10

### Lactate Crosslinker Mixture with 2,2-dimethoxy-1-(n-butyl)aza-2-silacyclopentane (BDC) and Additional Stabilization by 1,3-bis(trimethylsilyl)urea (BSU)

| | Component | wt.-% |
|---|---|---|
| 1 | α,ω-dihydroxy-dimethyl-polysiloxane | 52.1 |
| | 80.000 cSt | |
| 2 | Polydimethylsiloxane (PDMS) 100 cSt | 31.9 |
| 3 | Crosslinker 1: Vinyl-tris(ethyllactato)silane | 4.0 |
| 4 | Crosslinker 2: Methyl-tris(ethyllactato)silane | 1.0 |
| 5 | Stabilizer: 1.3 bis(trimethylsilyl)urea | 1.0 |
| | (BSU paste) | |
| 6 | Aminopropyltriethoxysilane (AMEO) | 0.2 |
| 7 | Pyrogenic silica, untreated | 8.5 |
| | BET surface 130-150 m2/g | |
| 8 | Catalyst 1:1 (w/w) Mixture of dialkyl zinc | 0.1 |
| | oxide and tetraalkoxysilane | |
| 9 | Adhesion promoter: 2,2-dimethoxy-1- | 1.2 |
| | (n-butyl)aza-2-silacyclopentane (BDC) | |

Polymer 80,000 cSt, PDMS 100 cSt are mixed under vacuum for 5 minutes. Then the crosslinker mixture of vinyl-tris(ethyllactato)silane and methyl-tris(ethyllactato)silane and the BSU paste are mixed in under vacuum for 5 minutes. Then the thixotropic agent AMEO was added under vacuum. The silica was then dispersed and stirred under vacuum until the paste was smooth. Finally, the catalyst was added as a 1:1 (w/w) mixture of dialkyl zinc oxide and tetraalkoxysilane and the adhesion promoter BDC under vacuum and the mixture was then stirred for 20 minutes.

The product was transparent and colorless and had a skin formation time of 9 minutes and a tack-free time of 21 minutes. It had good adhesion to all tested materials, i.e. glass, aluminum, PVC, sheet metal, steel, concrete, wood, painted wood, varnished wood, wood stained, polyamide, Al/Mg alloy, polystyrene and Metzoplast and had a pleasant odor.

### Example 11

### Oxime Crosslinker Mixture with 2,2-dimethoxy-1-(trimethylsilyl)aza-2-silacyclopentane (TMS-DC)

| | Component | wt.-% |
|---|---|---|
| 1 | α,ω-dihydroxy-dimethyl-polysiloxane | 52.0 |
| | 80.000 cSt | |
| 2 | Polydimethylsiloxane (PDMS) 100 cSt | 30.2 |
| 3 | Crosslinker 1: Vinyl-tris(2-pentanone | 1.3 |
| | oximo)silane | |
| 4 | Crosslinker 2: Methyl-tris(2-pentanone | 2.9 |
| | oximo)silane | |
| 5 | Pyrogenic silica, untreated | 10.3 |
| | BET surface 130-150 m2/g | |
| 6 | Catalyst 1:1 (w/w) Mixture of dialkyl zinc oxide | 0.12 |
| | and tetraalkoxysilane | |
| 7 | Adhesion promoter 1: 2,2-dimethoxy-1- | 1.2 |
| | (trimethylsilyl)aza-2-silacyclopentane (TMS-DC) | |
| 8 | Adhesion promoter 2 based on N-(2- | 0.5 |
| | aminoethyl)-3-aminopropyltrimethoxysilane | |
| | (DAMO) | |

Polymer 80,000 cSt, PDMS 100 cSt and the crosslinker mixture of oxime and oxime were mixed under vacuum. The silica was then dispersed and stirred under vacuum until the mass was smooth. Then the catalyst was mixed as a 1:1 (w/w) mixture of dialkyl zinc oxide and tetraalkoxysilane together with adhesion promoter 1 (2,2-dimethoxy-1-(trimethylsilyl)aza-2-silacyclopentane (TMS-DC)) and adhesion promoter 2 (based on N-(2-aminoethyl)-3-aminopropyltrimethoxysilane (DAMO)) under vacuum.

The product was transparent and colorless. It was characterized by a skin formation time of 6 minutes and a tack-free time of 15 minutes. The resulting sealant had good adhesion to all tested materials, i.e. glass, aluminum, PVC, sheet metal, steel, concrete, wood, wood varnished, wood glazed, polyamide, Al/Mg alloy and had a moderately pleasant odor.

The determined Shore A cureness was 22. Even after 4 weeks storage at 60° C. the sealant was stable (Shore A:21) and colorless. The extrusion when using a 2 mm diameter die at 5 bar and 30 seconds was 24.0 g. In addition, the sealant was early loadable after 60 min and showed a curing time on glass of 4 days.

General Execution of the Test Procedures:

1. Determination of the Tack-Free Time of Silicone Sealants

To determine the tack-free time, the temperature as well as the air humidity when the sealant is discharged must be determined using a suitable device and is to be noted in the corresponding protocol. A completely filled and closed cartridge (service life of the sealant after compounding at least 24 hours) is placed in a gun for silicone cartridges. Afterwards, an appropriate amount of silicone is sprayed onto a clean glass plate. The spatula is brushed quickly over the silicone to create a continuous silicone strip. The current time is taken. At appropriate time intervals, the adhesion-free time of the sealant to be determined is determined by lightly touching the silicone surface with a clean finger. If the sealant is tack-free, the current time is read off again.

2. Determination of the Extrusion of Silicone Sealants

A completely filled and sealed cartridge (service life of the sealant after compounding at least 24 hours) is placed in a compressed air gun for silicone cartridges and a suitable cartridge tip is screwed on. The compressed air pistol is connected to the compressed air supply and a pressure of 5 bar is set at the pressure gauge. First, a small amount of silicone is sprayed from the silicone cartridge onto a wiping paper so that the cartridge tip is completely filled with silicone. Then, an aluminium bowl is placed on the top pan scale and tared. Now, silicone is sprayed on the bowl for exactly 30 seconds and the weight is read off on the top pan scale.

3. Determination of the Stability of Silicone Sealants

To determine the stability, the temperature as well as the air humidity during the discharge of the sealant must be determined by means of a suitable device and is to be noted in the corresponding protocol. A completely filled and closed cartridge (service life of the sealant after compounding at least 24 hours) is placed in a gun for silicone cartridges. Then, a screw form is sprayed circularly onto a cardboard box (diameter approx. 3 cm). The carton with the silicone screw is now placed vertically and the current time is read off.

After 30 minutes it is observed whether the silicone screw has the original shape or whether the screw has flowed down. If the screw shape has not changed, the silicone sealant is stable.

4. Determination of the Curing of Silicone Sealants

To determine the curing time, the temperature as well as the air humidity during the discharge of the sealant must be determined by means of a suitable device and is to be noted in the corresponding protocol. A completely filled and closed cartridge (service life of the sealant after compounding at least 24 hours) is placed in a gun for silicone cartridges. Afterwards, an appropriate amount of silicone is sprayed onto a clean glass plate. The spatula is brushed quickly over the silicone to create a continuous silicone strip. At appropriate intervals (days), a small cross piece is carefully cut off the silicone with a knife and the curing of the sealant is assessed. If the inner part of the sealant body is still sticky and gel-like, the sealant is not yet fully cured and the determination is repeated. If the sealant is completely cured, the curing time is noted in days. If the sealant is still sticky after 7 days after application, the criterion curing is not OK.

5. Determination of the Adhesion of Silicone Sealants

To determine the adhesion, the temperature as well as the air humidity during the discharge of the sealant must be determined by means of a suitable device and is to be noted in the corresponding protocol. A completely filled and closed cartridge (service life of the sealant after compounding at least 24 hours) is placed in a gun for silicone cartridges. A silicone button is then sprayed onto an appropriate cleaned carrier material (e.g. glass, aluminum, wood, plastic, concrete, natural stone, etc.). After the complete curing of the sealant (approx. 48 h), the silicone button is pulled with the fingers to see if the silicone separates again from the carrier material or if the silicone has formed an intimate connection with the carrier material. If the silicone button can be pulled off easily, heavily or not at all from the carrier material, the adhesive property is judged as bad, medium or good.

6. Determination of the Odour of Silicone Sealants

A completely filled and sealed cartridge (service life of the sealant after compounding at least 24 hours) is placed in a gun for silicone cartridges. Then, an appropriate amount of silicone is sprayed onto a clean glass plate. The spatula is brushed quickly over the silicone to create a continuous silicone strip. The silicone sealant is then assessed with regard to its odour.

7. Determination of the Aspect of Silicone Sealants

A completely filled and sealed cartridge (service life of the sealant after compounding at least 24 hours) is placed in a gun for silicone cartridges. Then, an appropriate amount of silicone is sprayed onto a clean glass plate. The spatula is brushed quickly over the silicone to create a continuous silicone strip. The silicone sealant is then visually assessed for appearance, color and smoothness.

8. Determination of the Skin Formation Time of Silicone Sealants

To determine the skin formation time, the temperature as well as the air humidity during the discharge of the sealant must be determined by means of a suitable device and noted in the corresponding protocol. A completely filled and closed cartridge (service life of the sealant after compounding at least 24 hours) is placed in a gun for silicone cartridges. Afterwards, an appropriate amount of silicone is sprayed onto a clean glass plate. The spatula is brushed quickly over the silicone to create a continuous silicone strip. At appropriate intervals, the skin formation of the sealant to be determined is determined with a clean finger by light pressure on the silicone surface. If the sealant forms a skin on its surface so that no silicone residues remain on the finger, the measured time is taken from the stopwatch.

9. Tensile Test with Shoulder Rod S1 According to DIN 53504

For the determination of the silicone to be tested, the corresponding test number of the silicone cartridge and the test date must be noted in the protocol. The service life of the sealant after compounding must be at least 24 hours in the cartridge. The casting mould is wetted with washing-up liquid to prevent silicone from adhering to the metal. A completely filled and sealed cartridge is placed in a gun for silicone cartridges. The tip of the cartridge is removed. The silicone is then sprayed onto the matrix for the shoulder rod S 1 over the length and height of the milled out casting mould and immediately smoothed out with a spatula. After at least 24 hours, the curing of the silicone is checked by lifting the test specimen out of the matrix. There must be no sticky surface left. The shoulder rod must be visually perfect, without air and foreign inclusions or cracks. The test specimen is marked with the test number after it has been removed from the die. In the T 300 tensile tester, the tension clamps for the shoulder rod S 1 must be inserted. The testable shoulder rod is clamped between the upper and lower clamps in such a way that the web shows exactly 26 mm initial gauge length. The measuring data or measuring marks are reset to zero in the relaxed state. By pressing the start button the stretching of the test specimen or its measured value display starts. The device switches off automatically after the test specimen is torn. The measured values remain displayed and can be read directly

10. Tensile Test with H-Test Specimen According to DIN 8339

For the determination of the silicone to be tested, the corresponding test number of the silicone cartridge and the test date must be noted in the protocol. The service life of the sealant after compounding must be at least 24 hours in the cartridge.

A completely filled and sealed cartridge is placed in a gun for silicone cartridges. The tip of the cartridge is removed. The silicone is then sprayed onto the matrix over the length and height of the mould and immediately smoothed out with a spatula. The test specimen is then stored for 28 days under standard conditions. Before the tensile test, the test specimen is visually checked. The test specimen must not show any air inclusions or cracks.

In the MFC T 300 tensile tester, the tensile clamps for the H-test specimen must be inserted. The test specimen is clamped between the upper and lower clamps so that the distance is 12 mm. The measuring data or measuring marks are reset to zero in the relaxed state. By pressing the start button, the test specimen or its measured value display starts stretching. The device switches off automatically after the test specimen is torn. The measured values remain displayed and can be read off directly.

11. Tensile Test with H-Test Specimen According to DIN 8340

For the determination of the silicone to be tested, the corresponding test number of the silicone cartridge and the test date must be noted in the protocol. The service life of the sealant after compounding must be at least 24 hours in the cartridge. A completely filled and sealed cartridge is placed in a gun for silicone cartridges. The tip of the cartridge is removed. The silicone is then sprayed onto the matrix over the length and height of the mould and immediately smoothed out with a spatula. The test specimen is then stored for 28 days under standard conditions. Before the tensile test, the test specimen is visually checked. The test specimen must not show any air inclusions or cracks.

In the MFC T 300 tensile tester, the tensile clamps for the H-test specimen must be inserted. The test specimen is clamped between the upper and lower clamps so that the distance is 12 mm. The measuring data or measuring marks are reset to zero in the relaxed state. By pressing the start button, the test specimen or its measured value display starts stretching. The device switches off automatically after the test specimen is torn. The measured values remain displayed and can be read off directly.

12. Determination of the Storage Stability of Silicone Sealants

A completely filled and sealed cartridge is placed in the heated drying cabinet. According to the protocol Test Methods, the silicone sealant is stored at an appropriate temperature in the heated drying cabinet for a certain period of several weeks. At the end of the storage period, the cartridge is placed in a gun for silicone cartridges. Then an appropriate amount of silicone is sprayed onto a laid out flow cloth. With the spatula, the silicone is brushed quickly over the silicone, so that a continuous silicone strip is created. The silicone sealant is then evaluated with regard to PA-E0002 and PA-E0010.

13. Determination of the Early Load Capacity of Silicone Sealants

To determine the early load-bearing capacity, the temperature as well as the air humidity during the discharge of the sealant must be determined by means of a suitable device and noted in the corresponding protocol. A completely filled and closed cartridge (service life of the sealant after compounding at least 24 hours) is placed in a gun for silicone cartridges. Horizontal lines are first drawn on the cartridge at a distance of 3 cm each and then cut. Then, a corresponding amount of silicone is sprayed onto the cardboard. The spatula is used to stroke quickly over the silicone, so that a continuous silicone strip is created. The current time is read off. At equal intervals of 15 minutes, starting at the first line, the carton is bent to a right angle and the surface of the silicone is examined at the bend. If the silicone is completely or only partially torn at the kink, the determination is repeated at the next 3 cm line after another 15 minutes. If the silicone is elastic at the kink and no crack can be detected, the silicone is ready for early loading. The current time is read again.

14. Determination of the Shore Cureness of Silicone Sealants

A completely filled and sealed cartridge (service life of the sealant after compounding at least 24 hours) is placed in a gun for silicone cartridges. Then, an appropriate amount of silicone is sprayed onto a clean glass plate. The spatula is brushed quickly over the silicone to create a continuous silicone strip. When the sealant is completely cured (see PA-E0008), the shore cureness meter is placed on the silicone surface with both hands in a completely flat position and the maximum value of the shore cureness is read off. The measurement is repeated at least 5 times at different points on the silicone surface and an average value is calculated from the individual measurements.

### EMBODIMENTS

### Embodiment 1

Composition containing
a. a curing agent for silicone rubber compositions comprising a compound having the general structural formula R¹ₘSi(R)₄₋ₘ,
   wherein
   each R¹ independently represents an optionally substituted straight-chain or branched C1 to C16 alkyl group, an optionally substituted straight-chain or branched C2 to C16 alkenyl group or an optionally substituted C4 to C14 aryl group,
   m is an integer from 0 to 2,
   each R is independently selected from the group consisting of
      a hydroxycarboxylic acid ester residue having the general structural formula (I):

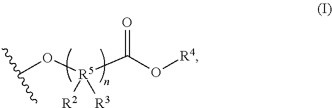

wherein
each R² independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group
each R³ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group
R⁴ represents an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group, a C5 to C15 aralkyl group or a C4 to C14 aryl group,
R⁵ is C or an optionally substituted saturated or partially unsaturated cyclic ring system having 4 to 14 C atoms or an optionally substituted aromatic group having 4 to 14 C atoms, and
n is an integer from 0 to 10,
   -a hydroxycarboxylic acid amide residue of the general structural formula (II):

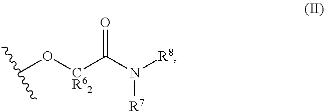

wherein
each R⁶ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group,
each R⁷ or R⁸ independently represents H or an optionally substituted, straight-chain or branched C1 to C16 alkyl group, an optionally substituted, straight-chain or branched C2 to C16 alkenyl group or an optionally substituted, straight-chain or branched C2 to C16 alkynyl group or a C4 to C14 aryl group,
   O—C(O)—R⁹, wherein R⁹ represents H, an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group or a C4 to C14 aryl group, and
   O—N═CR¹⁰ R¹¹, wherein R¹⁰ and R¹¹ independently represent H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group, and
b. at least one organosilane, in particular a heterocyclic organosilane as water scavenger, alcohol scavenger and/or hydroxide ion scavenger and
c. optionally at least one organopolysiloxane.

### Embodiment 2

Composition according to embodiment 1 characterized in that a heterocyclic organosilane is contained, wherein at least one silicon atom and at least one heteroatom are directly linked to one another and the heteroatom is selected from the group consisting of N, P, S or O.

### Embodiment 3

Composition according to embodiment 1 or 2 characterized in that one or more heterocyclic organosilanes are selected from the group of the general structural formulae (III), (IIIa), (IV), (IVa), (V), (Va) or mixtures thereof:

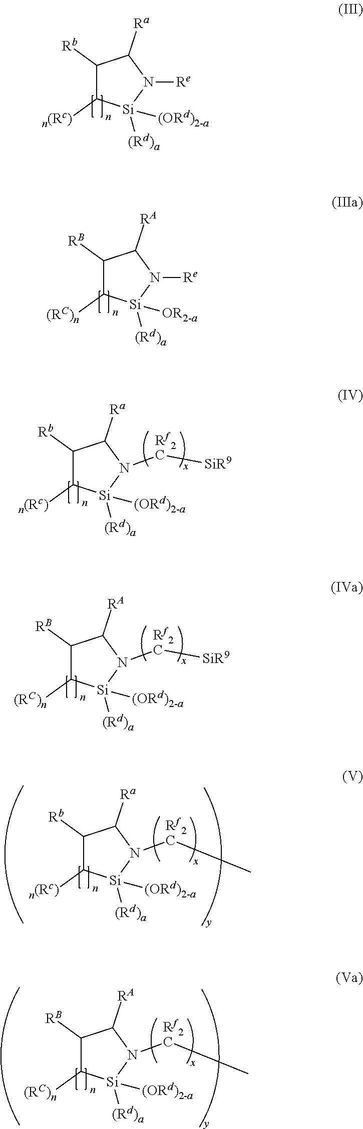

wherein
a is 0, 1 or 2;
x means 0 to 100;
y means 1 to 1000;
n means 0 to 6
   each R^{a}, R^{b}, R^{c}, R^{d}, R^{e}, R^{f} or R^{g} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group represents an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
      each R^{A} and/or R^{B} and/or (R^{C})ₙ taken together form a 4- to 10-membered ring, preferably a 5 to 8-membered ring, especially preferably a 5- to 6-membered ring.

### Embodiment 4

Composition according to embodiment 1, characterized in that one or more organosilanes are selected from the group consisting of iminosilanes of the general structural formula (VII), silanoaminosilanes of the general structural formula (VIII), non-cyclic organosilanes of the general structural formula (IX), amino-protecting group-containing organosilanes (IXa) to (IXe) derived from the general structural formula (IX) or mixtures thereof:

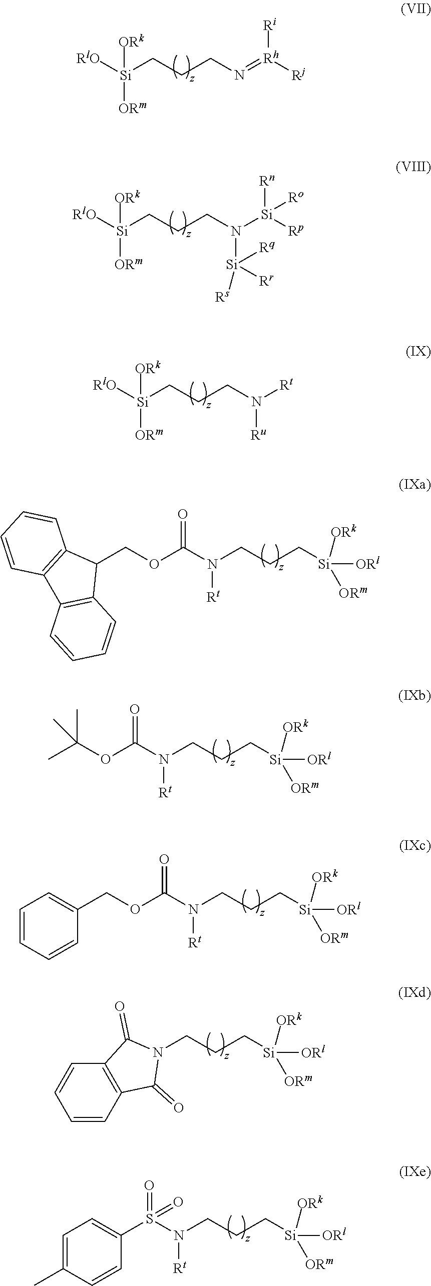

wherein
   R^{h} is C or Si,
   each Rⁱ, R^{j} independently represents H, —C(O)Rt, an optionally substituted straight-chain or branched C1 to C16 alkyl group, an optionally substituted straight-chain or branched C2 to C16 alkenyl group, or an optionally substituted C4 to C14 aryl group
   each R^{k}, R^{l}, R^{m} independently represents H, —C(O)R¹, an optionally substituted, straight-chain or branched C1 to C16 alkyl group, an optionally substituted, straight-chain or branched C2 to C16 alkenyl group, or an optionally substituted C4 to C14 aryl group
   each Rⁿ, R^{o}, R^{p}, R^{q}, R^{r}, R^{s} independently represents H, —O—R^{t}, —C(O)—R^{t}, —COOR^{t}, an optionally substituted, straight-chain or branched C1 to C16 alkyl group, an optionally substituted, straight-chain or branched C2 to C16 alkenyl group, or an optionally substituted C4 to C14 aryl group
   each R^{t}, R^{u} independently represents H, —OR¹, —C(O)R¹, —C(O)CF₃, —COOR¹, an optionally substituted straight-chain or branched C1 to C16 alkyl group, an optionally substituted straight-chain or branched C2 to C16 alkenyl group, an optionally substituted C4 to C14 aryl group, or a protecting group in particular a tert-butoxycarbonyl group, a fluorenylmethoxycarbonyl group, a benzyloxycarbonyl group, an allyloxycarbonyl group, an optionally substituted isoindole-1,3-dione group or a 3-methyl-benzenesulfone group, and
   z is an integer from 1 to 30.

### Embodiment 5

Composition at least comprising a mixture obtainable by mixing at least one curing agent according to embodiment 1a with at least one organosilane 4b and/or a heterocyclic organosilane according to embodiment 3b.

### Embodiment 6

Composition according to one of the above embodiments, wherein the organosilane, in particular heterocyclic organosilane, is contained at a maximum of 3 wt.-%, preferably at a maximum of 2 wt.-%, more preferably at a maximum of 1.5 wt.-%, in particular preferably at a maximum of 1.2 wt.-%, in each case based on the total weight of the composition.

### Embodiment 7

Composition according to one of the above embodiments, wherein the organosilane, in particular heterocyclic organosilane, is present in a proportion of 0.25 to 3 wt.-%, preferably from 0.25 to 2 wt.-%, particularly preferably from 0.5 to 1.5 wt.-%, particularly preferably from 0.8 to 1.2 wt.-%, based on the total weight of the silicone rubber mass.

### Embodiment 8

Composition according to any of the above embodiments, wherein the heterocyclic organosilane is a 4- to 10-membered heterocycle.

### Embodiment 9

Composition according to any of the above embodiments, wherein the heterocyclic organosilane is a 5- to 6-membered heterocycle.

### Embodiment 10

Composition according to one of the above embodiments, wherein the organosilane, in particular heterocyclic organosilane, consisting exclusively of silicon and heteroatoms.

### Embodiment 11

Composition according to embodiment 8 or 9, wherein the heterocycle contains a maximum of 5 heteroatoms selected from the group consisting of Si, N, P, S or O.

### Embodiment 12

Composition according to any one of the above embodiments 8 to 11, wherein the heterocycle containing at least one N.

### Embodiment 13

Composition according to one of the above embodiments, wherein the organosilane, in particular the heterocyclic organosilane is linked with at least one further cyclic ring system.

### Embodiment 14

Composition according to one of the above embodiments, wherein the silicon atom carries at least one OR^{d} radical and each R^{d} independently carries H or an optionally substituted, straight-chain or branched C1 to C20 alkyl group, an optionally substituted, straight-chain or branched C2 to C20 alkenyl group, an optionally substituted C3 to C20 cycloalkyl group, represents an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group.

### Embodiment 15

Composition according to one of the above embodiments, wherein the silicon atom carries at least one NR^{d1}R^{d1} radical and each R^{d1} independently carries H or an optionally substituted, straight-chain or branched C1 to C20 alkyl group, an optionally substituted, straight-chain or branched C2 to C20 alkenyl group, an optionally substituted C3 to C20 cycloalkyl group, represents an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group

### Embodiment 16

Composition according to one of the above embodiments, wherein the heteroatom is directly linked to another organosilane, preferably to a heterocyclic organosilane.

### Embodiment 17

Composition according to one of the above embodiments, wherein the heteroatom is connected via one or more carbon atoms to another organosilane, preferably to a heterocyclic organosilane.

### Embodiment 18

Composition according to any of the above embodiments, wherein the heterocyclic organosilane has at least one of the following structural formulae:

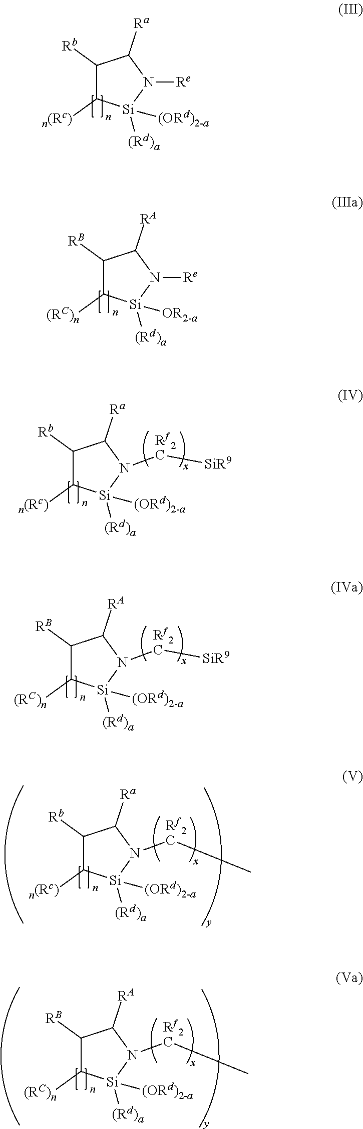

wherein
   a is 0, 1 or 2;
   x means 0 to 100;
   y means 1 to 1000;
   n means 0 to 6;
      each R^{a}, R^{b}, R^{c}, R^{d}, R^{e}, R^{f} or R^{g} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group represents an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
      each R^{A} and/or R^{B} and/or (R^{C}), taken together form a 4- to 10-membered ring, preferably a 5- to 8-membered ring, especially preferably a 5- to 6-membered ring.

### Embodiment 19

Composition according to any of the above embodiments, wherein the heterocyclic organosilane has at least one of the following structural formulae:

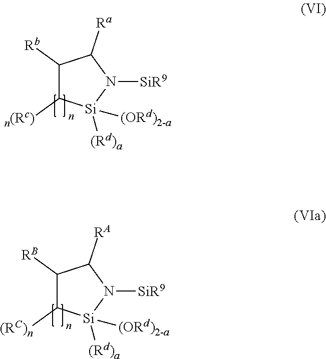

wherein
   a is 0, 1 or 2;
   x means 0 to 100;
   y means 1 to 1000;
   n means 0 to 6
      each R^{a}, R^{b}, R^{c}, R^{d}, or R⁹ is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
      R^{A} and/or R^{B} and/or (R^{C})ₙ taken together form a 4- to 10-membered ring, preferably a 5- to 8-membered ring, in particular preferably a 5- to 6-membered ring.

### Embodiment 20

Composition containing,
a. a curing agent for silicone rubber masses comprising a compound having the general structural formula R¹ₘSi(R)₄₋ₘ,
   wherein
   each R¹ independently represents an optionally substituted straight-chain or branched C1 to C16 alkyl group, an optionally substituted straight-chain or branched C2 to C16 alkenyl group or an optionally substituted C4 to C14 aryl group,
   m is an integer from 0 to 2,
   each R is independently selected from the group consisting of
      —O—N═CR¹⁰R¹¹, wherein R¹⁰ and R¹¹ independently represent H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group, and
b. at least one heterocyclic organosilane having at least one of the following structural formulae:

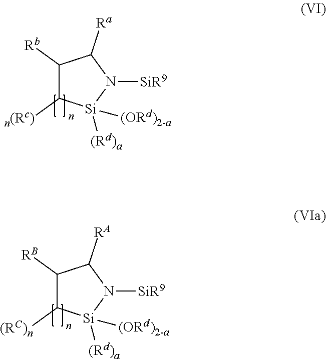

wherein
   a is 0, 1 or 2;
   x means 0 to 100;
   y means 1 to 1000;
   n means 0 to 6;
      each R^{a}, R^{b}, R^{c}, R^{d} or R^{g} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
      each R^{A} and/or R^{B} and/or (R^{C})ₙ taken together form a 4- to 10-membered ring, preferably a 5- to 8-membered ring, especially preferably a 5- to 6-membered ring.

### Embodiment 21

Composition according to embodiment 20, wherein the ring taken together by R^{A} and/or R^{B} and/or (R^{C})ₙ may contain at least one heteroatom Si, N, P, S or O, preferably Si, N, or S.

### Embodiment 22

Composition according to any of the above embodiments, wherein the heterocyclic organosilane has at least one of the following structural formulae:

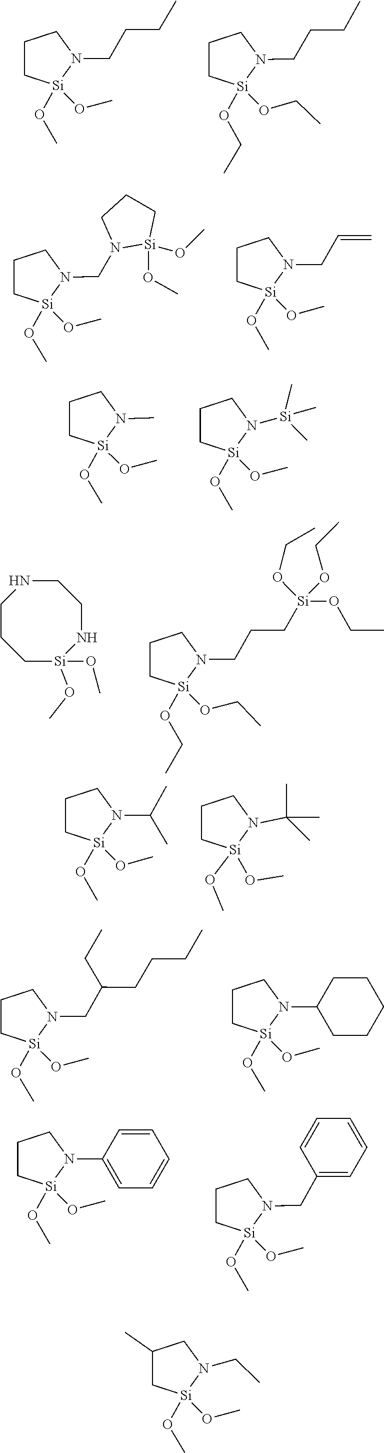

### Embodiment 23

A composition according to any of the above embodiments, wherein in the general structural formula R¹ₘSi(R)₄₋ₘ each R¹ is independently a residue of methyl, ethyl, propyl, vinyl, phenyl or allyl.

### Embodiment 24

Composition according to one of the above embodiments, wherein in the hydroxycarboxylic acid ester residue each R² and Ware independently selected from the group consisting of H, methyl, ethyl, propyl, isopropyl, butyl, n-butyl, sec-butyl, iso-butyl and tert-butyl, in particular from the group consisting of H and methyl.

### Embodiment 25

Composition according to any one of the above embodiments, wherein in the hydroxycarboxylic acid ester residue R⁴ is selected from the group consisting of phenyl, tolyl, naphthyl, benzyl, cyclohexyl, methyl, ethyl, propyl, isopropyl, butyl, n-butyl, sec-butyl, iso-butyl, tert-butyl, pentyl, n-pentyl, sec-pentyl, 3-pentyl, 2-methylbutyl, iso-pentyl, 3-methylbut-2-yl, 2-methylbut-2-yl, neopentyl, hexyl, heptyl, octyl, ethylhexyl, and 2-ethylhexyl.

### Embodiment 26

Composition according to one of the above embodiments, wherein in the hydroxycarboxylic acid ester residue R⁵ is a divalent benzene residue or R⁵C and R² and R³ are H or R⁵C and R²H and R³ methyl.

### Embodiment 27

Composition according to one of the above embodiments, wherein in the hydroxycarboxylic acid ester residue n is an integer from 1 to 5, in particular from 1 to 3, in particular 1.

### Embodiment 28

A composition according to any one of the above embodiments, wherein the curing agent is selected from the group consisting of tris(methyllactato)vinylsilane, tris(ethyllactato)vinylsilane, tris(ethylhexyllactato)vinylsilane, tris(methylsalicylato)vinylsilane, tris(ethylsalicylato)vinylsilane, tris(ethylhexylsalicylato)vinylsilane, tris(2-ethylhexylsalicylato)vinylsilane, tris(isopropylsalicylato)vinylsilane, tris(methyllactato)methylsilane, tris(ethyllactato)methylsilane, tris(ethylhexyllactato)methylsilane, tris-(methylsalicylato)methylsilane, tris(ethylsalicylato)methylsilane, tris(ethylhexylsalicylato)-methylsilane, tris(2-ethylhexylsalicylato)methylsilane, tris(3-aminopropyl)methylsilane, tris(5-aminopentyl)methylsilane, tris(methyllactato)propylsilane, tris(ethyllactato)-propylsilane, tris(ethylhexyllactato)propylsilane, tris(ethylsalicylato)propylsilane, tris-(ethylhexylsalicylato)propylsilane, tris(2-ethylhexylsalicylato)propylsilane, tris(isopropylsalicylato)propylsilane, tris(3-aminopropyl)propylsilane, tris(5-aminopentyl)propylsilane, tris(methyllactato)ethylsilane, tris(ethyllactato)ethylsilane, tris(ethylhexyllactato)ethylsilane, tris(methylsalicylato)ethylsilane, tris(ethylsalicylato)-ethylsilane, tris(ethylhexylsalicylato)ethylsilane, tris(2-ethylhexylsalicylato)ethylsilane, tris(isopropylsalicylato)ethylsilane, tris(3-aminopropyl)ethylsilane, tris(5-aminopentyl)ethylsilane, tris(methyllactato)phenylsilane, tris(ethyllactato)phenylsilane, tris(ethylhexyllactato)phenylsilane, tris(methylsalicylato)phenylsilane, tris(ethylsalicylato)phenylsilane, tris(ethylhexylsalicylato)phenylsilane, tris(2-ethylhexylsalicylato)phenylsilane, tris(isopropylsalicylato)phenylsilane, tris(3-aminopropyl)phenylsilane, tris(5-aminopentyl)phenylsilane, tetra(methyllactato)silane, tetra(ethyllactato)silane, tetra(ethylhexyllactato)silane, tetra(ethylhexylsalicylato)silane, tetra(2-ethylhexylsalicylato)silane, tetra(methylsalicylato)silane, tetra(isopropylsalicylato)silane, tetra(ethylsalicylato)silane, tetra(3-aminopropyl)silane, tetra(5-aminopentyl)silane and mixtures thereof.

### Embodiment 29

Composition according to one of the above embodiments, wherein the curing agent additionally contains a compound with the general structural formula R¹²ₒSi(R)₄₋ₒ, wherein R¹² is an optionally substituted, straight-chain or branched C1 to C16 alkyl group, in particular an optionally substituted, straight-chain or branched C1 to C12 or a C1 to C8 alkyl group or a methyl or propyl group, or an optionally substituted straight-chain or branched C2- to C16-alkenyl group, in particular an optionally substituted, straight-chain or branched C2- to C12- or a C2- to C8-alkenyl group or a vinyl group or an optionally substituted C4- to C14-aryl group or a phenyl group and R is defined according to one of claims 1, 15 or 21 and o is an integer from 0 to 2 and wherein R¹ₘSi(R)₄₋ₘ and R¹²ₒSi(R)₄₋ₒ cannot be the same.

### Embodiment 30

Composition obtainable by mixing at least one curing agent according to one of the embodiments 1 or 23 to 28 or a curing agent mixture according to embodiment 29 with an organosilane, in particular heterocyclic organosilane according to one of the embodiments 1 to 22.

### Embodiment 31

Composition according to one of the above embodiments, comprising at least one organopolysiloxane, preferably a α,ω functional diorganopolysiloxane.

### Embodiment 32

Composition according to embodiment 31, wherein at least one of the at least one organopolysiloxane is a α, ω-dihydroxydialkylorganopolysiloxane, preferably a α, ω-dihydroxydi-C₁₋₆-alkylorganopolysiloxane and particularly preferably a α, ω-dihydroxydimethylpolysiloxane.

### Embodiment 33

Composition according to embodiment 31 or 32, wherein at least one of the at least one organopolysiloxane has a viscosity of 1,000 to 500,000 cst, preferably of 20,000 to 200,000 cst and particularly preferably of 50,000 to 125,000 cst.

### Embodiment 34

A composition according to any of the above embodiments, comprising a filler preferably selected from the group consisting of silicas, carbon black, quartz, chalks, metal salts, metal oxides and any mixtures of two or more of the foregoing compounds, most preferably silica and most preferably silica having a BET specific surface area of 100 to 200 m²/g.

### Embodiment 35

A composition according to any one of the above embodiments, which contains a thixotropic agent which is preferably aminopropyltriethoxysilane.

### Embodiment 36

Composition according to any of the above embodiments, comprising a plasticizer which is preferably a polydiorganosiloxane without functional end groups, more preferably a polydialkylsiloxane without functional end groups, more preferably a polydi-C₁₋₆-alkylsiloxane without functional end groups and most preferably a polydimethylsiloxane without functional end groups.

### Embodiment 37

Composition according to any of the above embodiments, comprising at least one catalyst preferably selected from the group consisting of tin carboxylates, titanium, zirconium or aluminium compounds, more preferably selected from the group consisting of titanium silsesquioxanes (Ti-POSS), dibutyl tin dilaurate, dibutyl tin divaleriate, dibutyl tin diacetate, dibutyl tin dineodecanoate, dibutyl tin diacetylacetonate, dioctyl tin bis(2-ethylhexanoate), dibutyl tin dimaleate, tin (II) octoate and butyl tin tris(2-ethylhexanoate), and most preferably selected from the group consisting of (iBu)₇Si₇O₁₂TiOEt, (C₃H₁₇)₇Si₇O₁₂TiOEt, dibutyltin dilaurate, dibutyltin diacetate and tin(II) octoate.

### Embodiment 38

Composition according to one of the above embodiments, wherein it contains:
a) 30 to 70 wt.-% α, ω-dihydroxydialkylorganopolysiloxane,
b) 1 to 10 wt.-% of the curing agent and
c) 0.1 to 10 wt.-% of organosilane, in particular heterocyclic organosilane.

### Embodiment 39

Composition according to embodiment 38, wherein it contains:
a) 30 to 70 wt.-% α, ω-dihydroxydialkylorganopolysiloxane,
b) 1 to 10 wt.-% of the curing agent,
c) 0.1 to 10 wt.-% of organosilane, in particular heterocyclic organosilane,
d) 20 to 50 wt.-% plasticizer,
e) 1 to 20 wt.-% filler and
f) 0.01 to 1 wt.-% catalyst.

### Embodiment 40

Composition according to embodiment 39, wherein it contains:
a) 40 to 60 wt.-% α, ω-dihydroxydialkylorganopolysiloxane,
b) 3 to 7 wt.-% of the curing agent,
c) 0.5 to 2.5 wt.-% of organosilane, in particular heterocyclic organosilane,
d) 25 to 40 wt.-% plasticizer,
e) 5 to 15 wt.-% filler and
f) 0.05 to 0.5 wt.-% catalyst.

### Embodiment 41

A process for preparing a composition comprising the following steps:
(i) Mixing an organopolysiloxane, preferably of a α, ω-dihydroxydialkylorganopolysiloxane with a crosslinker or crosslinker mixture according to one of the above embodiments 1 to 40 under vacuum;
(ii) Mixing in under vacuum of an organosilane, in particular heterocyclic organosilane according to one of the above embodiments 1 to 40 and a catalyst according to embodiment 37.

### Embodiment 42

A process for preparing a composition comprising the following steps:
(i) Mixing an organopolysiloxane, preferably of a α, ω-dihydroxydialkylorganopolysiloxane with a plasticizer according to embodiment 36 and a crosslinker or crosslinker mixture according to one of the above embodiments 1 to 40 under vacuum;
(ii) Addition of a thixotropic agent, preferably aminopropyltriethoxysilane;
(iii) Dispersion of a filler, especially silica;
(iv) Mixing in under vacuum of an organosilane, in particular heterocyclic organosilane according to one of the above embodiments 1 to 40 and a catalyst according to embodiment 37.

### Embodiment 43

Use of an organosilane, in particular heterocyclic organosilane according to one of the above embodiments as a water scavenger, alcohol scavenger and/or hydroxide ion scavenger.

### Embodiment 44

Use of a composition according to any one of the above embodiments 1 to 40 for the manufacture of a silicone rubber mass.

### Embodiment 45

Use of a reaction product of at least one organosilane, in particular heterocyclic organosilane according to one of the above embodiments 1 to 40 with water, as adhesion promoter.

### Embodiment 46

Use of a composition according to one of the above embodiments as a sealant, adhesive, casting compound or coating agent.

### Embodiment 47

Use of an organosilane, in particular a heterocyclic organosilane according to one of the above embodiments, as a stabilizer, wherein the latter carries a trialkylsilyl group, preferably a trimethylsilyl group, on at least one heteroatom.

1. Composition comprising
a. a curing agent for silicone rubber masses comprising a compound having the general structural formula R¹ₘSi(R)₄₋ₘ,
wherein
each R¹ independently represents an optionally substituted straight-chain or branched C1 to C16 alkyl group, an optionally substituted straight-chain or branched C2 to C16 alkenyl group or an optionally substituted C4 to C14 aryl group,
m is an integer from 0 to 2,
each R is independently selected from the group consisting of
a hydroxycarboxylic acid ester residue having the general structural formula (I): 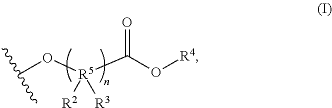
wherein
each R² independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group,
each R³ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group,
R⁴ represents an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group, a C5 to C15 aralkyl group or a C4 to C14 aryl group,
R⁵ is C or an optionally substituted saturated or partially unsaturated cyclic ring system having 4 to 14 C atoms or an optionally substituted aromatic group having 4 to 14 C atoms, and
n is an integer from 0 to 10,
a hydroxycarboxylic acid amide residue of the general structural formula (II): 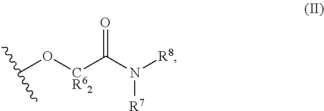
wherein
each R⁶ independently represents H or an optionally substituted, straight-chain or branched C1 to C16 alkyl group, an optionally substituted, straight-chain or branched C2 to C16 alkenyl group, or an optionally substituted, straight-chain or branched C2 to C16 alkynyl group, or a C4 to C14 aryl group,
each R⁷ or R⁸ independently represents H or an optionally substituted, straight-chain or branched C1 to C16 alkyl group, an optionally substituted, straight-chain or branched C2 to C16 alkenyl group or an optionally substituted, straight-chain or branched C2 to C16 alkynyl group or a C4 to C14 aryl group,
—O—C(O)—R⁹, wherein R⁹ means H, an optionally substituted, straight-chain or branched C1 to C16 alkyl group, an optionally substituted, straight-chain or branched C2 to C16 alkenyl group or an optionally substituted, straight-chain or branched C2 to C16 alkynyl group, a C4 to C14 cycloalkyl group or a C4 to C14 aryl group, and
—O—N═CR¹⁰R¹¹, wherein R¹⁰ and R¹¹ independently mean H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group,
and
b. at least one organosilane as water scavenger, alcohol scavenger and/or hydroxide ion scavenger and
c. optionally at least one organopolysiloxane.

2. Composition according to claim 1 characterized in that a heterocyclic organosilane is contained, wherein at least one silicon atom and at least one heteroatom are directly linked to one another and the heteroatom is selected from the group consisting of N, P, S or O.

3. Composition according to claim 2 characterized in that one or more heterocyclic organosilanes are selected from the group of the general structural formulae (III), (IIIa), (IV), (IVa), (V), (Va) or mixtures thereof: 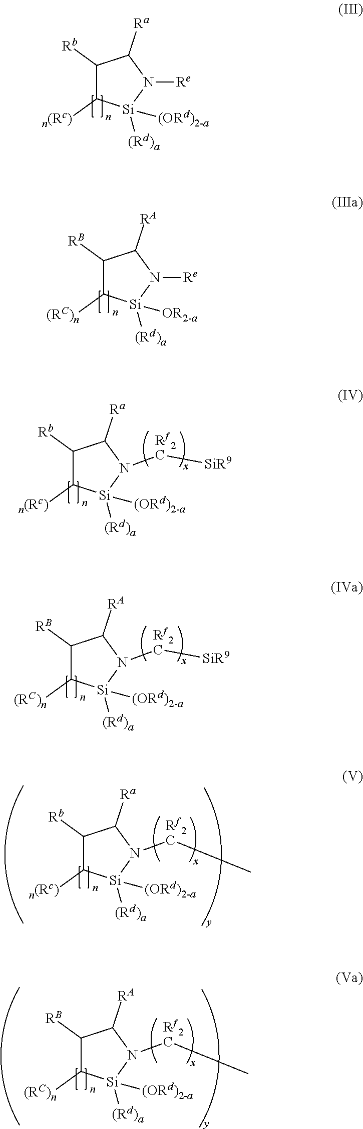
wherein
a is 0, 1 or 2;
x means 0 to 100;
y means 1 to 1000;
n means 0 to 6
each R^{a}, R^{b}, R^{c}, R^{d}, R^{e}, R^{f} or R^{g} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
each R^{A} and/or R^{B} and/or (R^{C})ₙ taken together form a 4- to 10-membered ring.

4. Composition according to claim 1, characterized in that one or more organosilanes are selected from the group consisting of iminosilanes of the general structural formula (VII), silanoaminosilanes of the general structural formula (VIII), non-cyclic organosilanes of the general structural formula (IX), amino-protecting group-containing organosilanes (IXa) to (IXe) derived from the general structural formula (IX) or mixtures thereof: 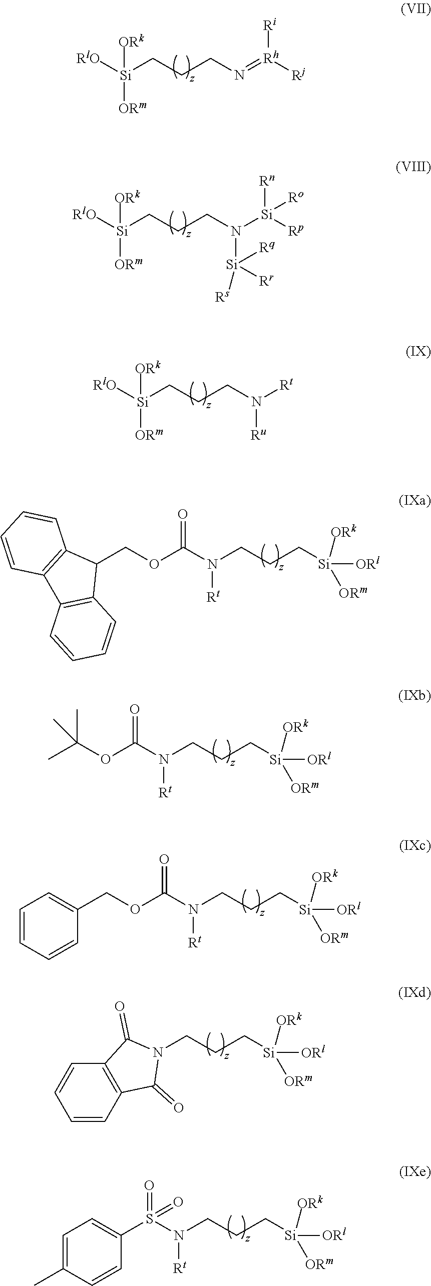
wherein
R^{h} is C or Si;
each Rⁱ, R^{j} independently mean H, —C(O)R^{t}, an optionally substituted straight-chain or branched C1 to C16 alkyl group, an optionally substituted straight-chain or branched C2 to C16 alkenyl group, or an optionally substituted C4 to C14 aryl group
each R^{k}, R^{l}, R^{m} independently mean H, —C(O)R^{t}, an optionally substituted, straight-chain or branched C1 to C16 alkyl group, an optionally substituted, straight-chain or branched C2 to C16 alkenyl group, or an optionally substituted C4 to C14 aryl group
each Rⁿ, R^{o}, R^{p}, R^{q}, R^{r}, R^{s} independently mean H, —O—R^{t}, —C(O)—R^{t}, —COOR^{t}, an optionally substituted, straight-chain or branched C1 to C16 alkyl group, an optionally substituted, straight-chain or branched C2 to C16 alkenyl group, or an optionally substituted C4 to C14 aryl group
each R^{t}, R^{u} independently mean H, —ORⁱ, —C(O)Rⁱ, —C(O)CF₃, —COORⁱ, an optionally substituted straight-chain or branched C1 to C16 alkyl group, an optionally substituted straight-chain or branched C2 to C16 alkenyl group, an optionally substituted C4 to C14 aryl group, or a protecting group in particular a tert-butoxycarbonyl group, a fluorenylmethoxycarbonyl group, a benzyloxycarbonyl group, an allyloxycarbonyl group, an optionally substituted isoindole-1,3-dione group or a 3-methyl-benzenesulfone group, and
z is an integer from 1 to 30.

5. Composition at least comprising a mixture obtainable by mixing at least one curing agent according to claim 1a with at least one organosilane 4b and/or a heterocyclic organosilane according to claim 3b.

6. Composition according to claim 1, characterized in that the organosilane is contained at a maximum of 3 wt.-% based on the total weight of the composition.

7. Composition according to claim 2, characterized in that the heterocyclic organosilane is a 4- to 10-membered heterocycle.

8. Composition according to claim 2 characterized in that the heterocyclic organosilane is a 5- to 6-membered heterocycle.

9. Composition according to claim 6, characterized in that the heterocycle contains at least one N.

10. Composition according to claim 1, characterized in that the silicon atom carries at least one OR^{d} residue and each R^{d} independently carries H or an optionally substituted, straight-chain or branched C1 to C20 alkyl group, an optionally substituted, straight-chain or branched C2 to C20 alkenyl group, an optionally substituted C3 to C20 cycloalkyl group, represents an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group.

11. Composition according to claim 2, characterized in that the heterocyclic organosilane has at least one of the following structural formulae: 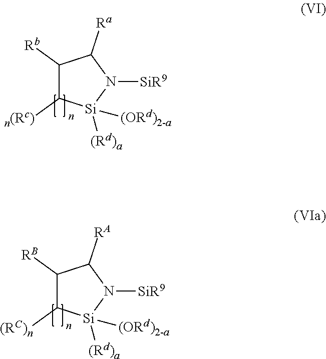
wherein
a is 0, 1 or 2;
x means 0 to 100;
y means 1 to 1000;
n means 0 to 6
each R^{a}, R^{b}, R^{c}, R^{d}, or R^{g} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
R^{A} and/or R^{B} and/or (R^{C})ₙ taken together form a 4- to 10-membered ring.

12. Composition comprising,
a. a curing agent for silicone rubber masses comprising a compound having the general structural formula R¹ₘSi(R)₄₋ₘ,
wherein
each R¹ independently means an optionally substituted straight-chain or branched C1 to C16 alkyl group, an optionally substituted straight-chain or branched C2 to C16 alkenyl group or an optionally substituted C4 to C14 aryl group,
m is an integer from 0 to 2,
each R is independently selected from the group consisting of
—O—N═CR¹⁰R¹¹, wherein R¹⁰ and R¹¹ independently means H, an optionally substituted straight-chain or branched C1 to C16 alkyl group, an optionally substituted straight-chain or branched C2 to C16 alkenyl group or an optionally substituted straight-chain or branched C2 to C16 alkynyl group, a C4 to C14 cycloalkyl group or a C4 to C14 aryl group,
and
b. at least one heterocyclic organosilane having at least one of the following structural formulae: 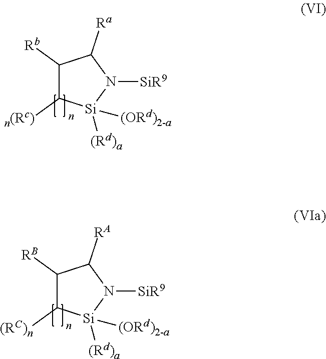
wherein
a is 0, 1 or 2;
x means 0 to 100;
y means 1 to 1000;
n means 0 to 6;
each R^{a}, R^{b}, R^{c}, R^{d} or R^{g} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight, branched or cyclic C4 to C20 alkynyl group or an optionally substituted, straight or branched C2 to C20 heteroalkyl group, an optionally substituted, straight, branched or cyclic C3 to C20 heteroalkenyl group or an optionally substituted C4 to C14 aryl or heteroaryl group;
each R^{A} and/or R^{B} and/or (R^{C})ₙ taken together form a 4- to 10-membered ring.

13. Composition according to claim 12, characterized in that it contains at least one organopolysiloxane.

14. Composition according to claim 12, characterized in that it contains
a) 30 to 70 wt.-% α, ω-dihydroxydialkyl organopolysiloxane,
b) 1 to 10 wt.-% of curing agent and
c) 0.1 to 10 wt.-% organosilane.

15. A process for preparing a composition comprising the following steps:
(i) Mixing an organopolysiloxane with a crosslinker or a crosslinker mixture according to claim 1 under vacuum;
(ii) Mixing in an organosilane and a catalyst under vacuum, wherein the catalyst is selected from the group consisting of tin carboxylates, titanium, zirconium or aluminium compounds.

16. Use of an organosilane of claim 1 as a water scavenger, alcohol scavenger and/or hydroxide ion scavenger.

17. Use of a composition of claim 1 for the manufacture of a silicone rubber composition.

18. Use of a reaction product of at least one organosilane with water, as adhesion promoter.

19. Use of a composition of claim 1 as a sealant, adhesive, potting compound or coating agent.

20. Use of an organosilane claim 1 as a stabilizer, characterized in that it carries a trialkylsilyl group on at least one heteroatom.
